(19) United States
(12) Patent Application Publication
(10) Pub. No.: US 2013/0339097 A1
(43) Pub. Date: Dec. 19, 2013

(54) System and Methods for Revenue and Impact Analysis of Price Protection and Price Caps

(71) Applicant: Vendavo, Inc., Mountain View, CA (US)

(72) Inventors: Rajeev Bansal, Fremont, CA (US); Jufang Wang, San Jose, CA (US); Shankar Sundaram, San Jose, CA (US); Niel Esary, Mountain View, CA (US)

(21) Appl. No.: 13/945,894

(22) Filed: Jul. 18, 2013

Related U.S. Application Data
(63) Continuation-in-part of application No. 13/907,860, filed on Jun. 1, 2013.
Application No. 13/907,860 is a continuation of application No. 10/857,262, filed on May 28, 2004, now Pat. No. 8,458,060.

(51) Int. Cl. G06Q 30/02

(52) U.S. Cl. CPC G06Q 30/0206
USPC 705/7.35

(57) ABSTRACT

The present invention relates to systems and methods for analyzing the impact of price protection and price cap terms in an integrated price management system. In some embodiments, the method includes negotiation of price protection and price cap terms. Next the method enforces the price protection and price cap terms. This enforcement may include applying and/or overriding the term on a manual price change or upon a mass price change. These terms are then analyzed for price leakage by product, by deal, by customer and by sales representative. This analysis may include the generation of a waterfall diagram for the deal. Adjustments for all price protection and price cap terms are generated (a price protection adjustment and a price cap adjustment) and these adjustments are then applied to the waterfall.

### CROSS REFERENCE TO RELATED APPLICATIONS

This application is a continuation-in-part of U.S. patent application Ser. No. 13/907,860, filed on Jun. 1, 2013, by Niel Esary et al., entitled “System and Method for Organizing Price Modeling Data using Hierarchically Organized Portfolios”, currently pending, which is a continuation of U.S. patent application Ser. No. 10/857,262, filed on May 28, 2004, by Niel Esary et al., entitled “System and Method for Organizing Price Modeling Data using Hierarchically Organized Portfolios”, now U.S. Pat. No. 8,458,060, which applications are incorporated herein in their entirety by this reference.

This application is related to co-pending application Ser. No. ______, filed Jul. 18, 2013, by Rajeev Bansal et al., entitled “System and Methods for Measuring Effectiveness for Strategic Mass Price Change” which application is incorporated herein in its entirety by this reference.

### BACKGROUND OF THE INVENTION

The present invention relates to business to business market price control and management systems. More particularly, the present invention relates to systems and methods for price protection and price capping which reduces pricing risk in volatile markets.

There are major challenges in business to business (hereinafter “B2B”) markets which hinder the effectiveness of classical approaches to analyzing pricing impacts and thus optimization or guidance of pricing strategies. Classical approaches to price optimization typically rely upon databases of extensive transaction data which may then be modeled for demand. The effectiveness of classical price optimization approaches depends upon a rich transaction history where prices have changed, and consumer reactions to these price changes are recorded. Thus, classical price optimization approaches work best where there is a wide customer base and many products, such as in Business to Consumer (hereinafter “B2C”) settings.

Unlike B2C environments, in B2B markets a small number of customers represent the lion's share of the business. Managing the prices of these key customers is where most of the pricing opportunity lies.

One approach to analyzing B2B markets for the generation of pricing opportunity insights is the utilization of pricing protection and pricing cap terms. These contractual terms are well established mechanisms for hedging risk in pricing negotiations for long term contracts and/or for volatile markets. For sellers, pricing protection and cap terms are a source of significant price and margin leakage. For all parties involved, tracking and complying with price protection and price cap terms is a significant administrative burden.

Price protection keeps customer price unchanged for a protected duration of time. Price changes may be passed to the customer after the protected time period. In contrast, price caps are limits on the amplitude of a price change during a given time period. Price caps smooth our price volatility for the buyers.

Unfortunately, since the application of price cap terms and price protection terms is typically manually driven, these terms typically requires substantial administrative overhead and costs. Further, when prices are not altered as quickly as allowed under these terms, profitability may suffer. Lastly, all current methods of employing these terms do not allow for previewing the impact upon profits that pricing caps or protections may result in.

As such an urgent need exists for a system and method for price protection and price caps. Such systems and methods enable an improvement in profitability, reduction in pricing risk, and the ability to preview these terms prior to implementation.

### SUMMARY OF THE INVENTION

The present invention discloses business to business market price control and management systems. More particularly, the present invention teaches systems and methods for analyzing the impact of price protection and price cap terms in an integrated price management system.

In some embodiments, the method includes negotiation of price protection and price cap terms. The price protection term limits when a price change can go into effect. A price cap term limits the degree of price change allowed in a given period. The negotiation of the price protection and the price cap term includes any of adding of a new term, editing of the term, ending of the term, renewal of the term, and workflow approval of the term. The price protection term includes a validity range, type (delayed, firm-trough, or rolling), and period. It may also include a base price, a periodic increase cap, a periodic decrease cap, an overall increase cap, an overall decrease cap, a periodic length, and an overall length.

Next the method enforces the price protection and price cap terms. This enforcement may include applying and/or overriding the term on a manual price change or upon a mass price change. These terms are then analyzed for price leakage by product, by deal, by customer and by sales representative. This analysis may include the generation of a waterfall diagram for the deal. Adjustments for all price protection and price cap terms are generated (a price protection adjustment and a price cap adjustment) and these adjustments are then applied to the waterfall.

Note that the various features of the present invention described above can be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a simple graphical representation of an enterprise level pricing environment, in accordance with some embodiments;

FIG. 2 is a simplified graphical representation of a price modeling environment where an embodiment of the present invention may be utilized;

FIG. 3 is a simplified graphical representation of dataflow within a price modeling environment where an embodiment of the present invention may be utilized;

FIG. 4 is a flow chart illustrating a technique for quote generation, in accordance with some embodiments;

FIG. 5 is a schematic of a portfolio hierarchy, in accordance with some embodiments;

FIG. 6 is an example schematic diagram illustrating an enterprise pricing system, in accordance with some embodiments;

FIG. 7 is a more detailed example block diagram of the enterprise pricing system, in accordance with some embodiments;

FIG. 8 is a more detailed example block diagram illustrating the price protection engine, in accordance with some embodiments;

FIG. 9 is a more detailed example block diagram illustrating the price cap engine, in accordance with some embodiments;

FIG. 10 is a flow chart illustrating an exemplary method for deal negotiation and compliance with price protection and price cap, in accordance with some embodiments;

FIG. 11 is a flow chart illustrating an exemplary method for the step of deal negotiation of FIG. 10;

FIG. 12 is a flow chart illustrating an exemplary method for the step of applying price protection and cap terms of FIG. 10;

FIG. 13 is a flow chart illustrating an exemplary method for the step of leakage analysis of FIG. 10;

FIG. 14 is a diagram illustrating a delay price protection term, in accordance with some embodiments;

FIG. 15 is a diagram illustrating a firm-through based price protection term, in accordance with some embodiments;

FIG. 16 is a diagram illustrating a rolling price protection term, in accordance with some embodiments;

FIG. 17 is a diagram illustrating a rolling and delayed price protection term, in accordance with some embodiments;

FIG. 18 is a diagram illustrating a delay price protection term in conjunction with a cap term, in accordance with some embodiments;

FIG. 19 is a diagram illustrating a delay price protection term in conjunction with a cap term in a waterfall design, in accordance with some embodiments;

FIGS. 20-33 are example screenshots of the price management systems with price protection and price caps, in accordance with some embodiments; and

FIGS. 34A and 34B are example illustrations of a computer system capable of embodying the current invention.

### DETAILED DESCRIPTION

The present invention will now be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

As previously discussed, traditional techniques used to implement price protection or price cap terms are plagued by enormous administrative overhead, lost opportunity, and an inability to predict the impact of the terms over a set of deals.

In order to address these deficiencies, a system for price protection and price caps is presented. This system enables the reduction in pricing volatility, increased profitability via leakage reduction, and previewing impacts of pricing protection and cap terms.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Enterprise Architecture

Price protection and pricing caps have particular benefit in the B2B environment in that B2B markets often rely upon thin margins, large volumes and are often subject to swings in prices for raw materials. Thus, a brief overview of such enterprise architecture will be provided in order to properly orient the reader.

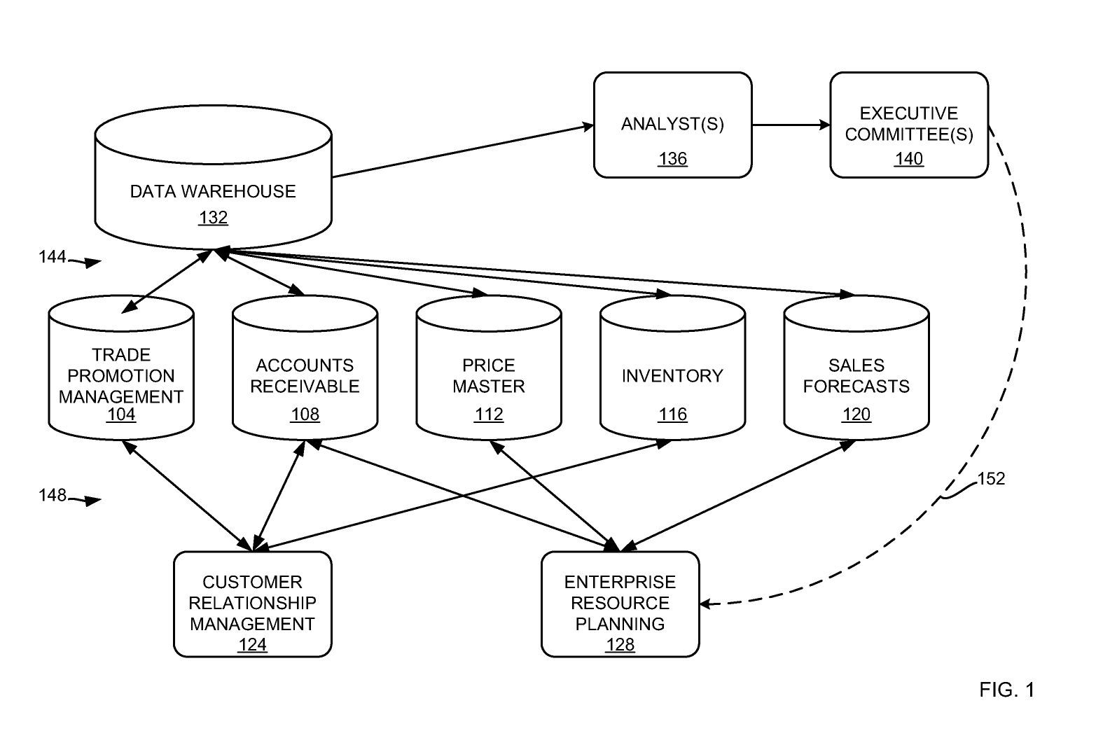

To facilitate discussion, FIG. 1 is a simplified graphical representation of an enterprise pricing environment. Several example databases (104-120) are illustrated to represent the various sources of working data. These might include, for example, Trade Promotion Management (TPM) 104, Accounts Receivable (AR) 108, Price Master (PM) 112, Inventory 116, and Sales Forecasts 120. The data in those repositories may be utilized on an ad hoc basis by Customer Relationship Management (CRM) 124, and Enterprise Resource Planning (ERP) 128 entities to produce and post sales transactions. The various connections 148 established between the repositories and the entities may supply information such as price lists as well as gather information such as invoices, rebates, freight, and cost information.

The wealth of information contained in the various databases (104-120) however, is not “readable” by executive management teams due in part to accessibility and in part to volume. That is, even though the data in the various repositories may be related through a Relational Database Management System (RDMS), the task of gathering data from disparate sources can be complex or impossible depending on the organization and integration of legacy systems upon which these systems may be created. In one instance, all of the various sources may be linked to a Data Warehouse 132 by various connections 144. Typically, the data from the various sources is aggregated to reduce it to a manageable or human comprehensible size. Thus, price lists may contain average prices over some selected temporal interval. In this manner, the data may be reduced. However, with data reduction, individual transactions may be lost. Thus, CRM 124 and ERP 128 connections to an aggregated data source may not be viable

Analysts 136, on the other hand, may benefit from the aggregated data from a data warehouse. Thus, an analyst 136 may compare average pricing across several regions within a desired temporal interval and then condense that analysis into a report to an executive committee 140. An executive committee 140 may then, in turn, develop policies directed toward price structuring based on the analysis returned from an analyst 136. Those policies may then be returned to CRM 124 and ERP 128 entities to guide pricing activities via some communication channel 152 as determined by a particular enterprise.

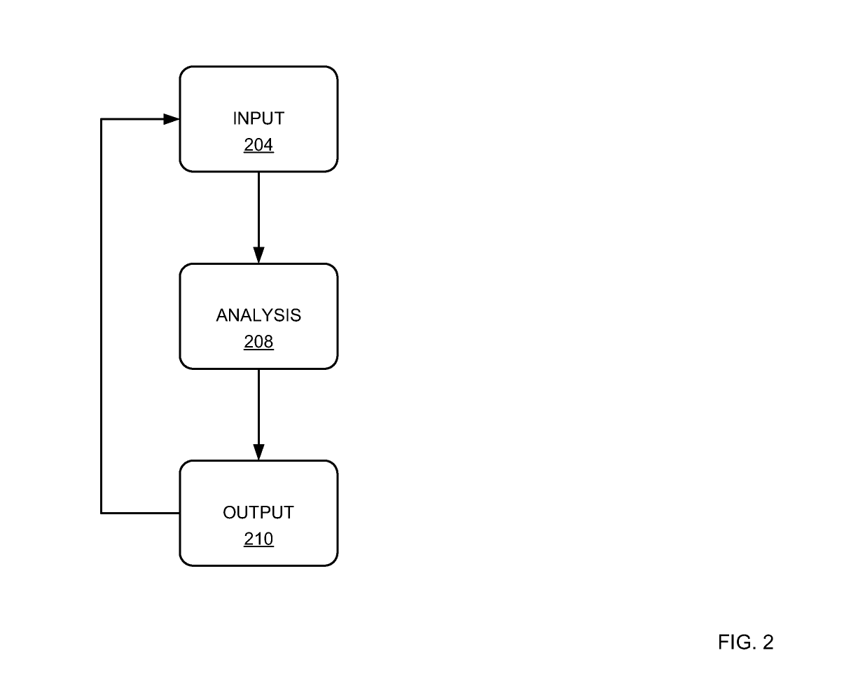

FIG. 2 illustrates a simplified graphical representation of a closed-loop system. As can be appreciated closed-loop systems are common in, for example, the mechanical and electromechanical arts. In general, a closed-loop system is a control system in which the output is continuously modified by feedback from the environment. As illustrated, for example, an input at a step 204 would be a feedback element. Inputs may be any desired indicator or metric that is measurable in some way. For example, an input may be a temperature reading taken from a thermocouple sensor. The input is then analyzed at a step 208. Many types of analysis are available depending on the intended use. simple comparison against a set value is one example. Another example might include advanced statistical analysis where appropriate. Thus, as can be appreciated, analysis in closed-loop systems may be highly complex.

An output is generated next at a step 210 based on the analysis of step 208. An output may be any operation that is intended to affect a condition of the desired system. In the above thermocouple example, a temperature may be read (e.g., input); compared against a set temperature (analysis); and affected by turning on or off a heating element depending on the comparison (output). Finally, the system loops back to the input and continues until the system, or a user terminates the process.

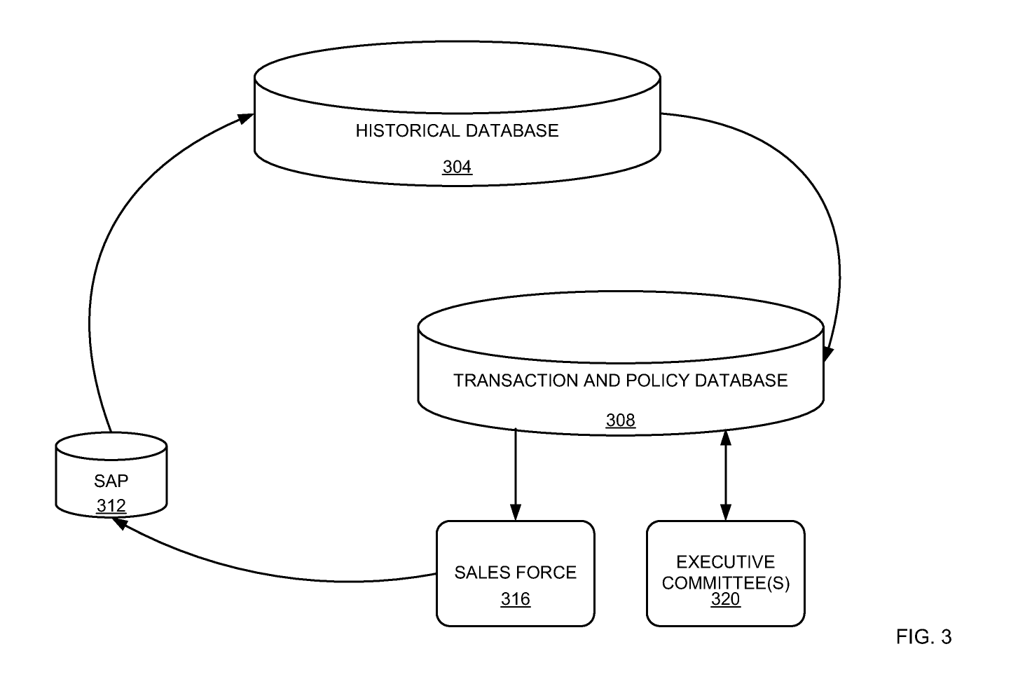

As pertains to the present disclosure, FIG. 3 is a simplified graphical representation of a closed-loop implementation of an embodiment of the present invention in a price modeling environment. At a first step 304, data is input into a historical database. A historical database, under the present invention may contain any of a number of inputs. In one embodiment of the present invention, a historical database may include sales transactions. In other embodiments of the present invention, a historical database may include waterfall records. A group of associated waterfall records may be defined as a price adjustment continuum. For example, in a transactional sales environment, an invoice price from a transaction may be affected by a rebate such that: invoice price=retail price−rebate. In this example, one waterfall record is a rebate. The rebate represents a price adjustment to the retail price that affects the invoice price. Rebate may also be thought of as a “leakage” in that the profitability of a sale is indirectly proportional to the amount of leakage in a given system. In a price modeling environment, metrics, like rebates for example, that may affect the profitability of a transaction, may be stored at a transaction level in a historical database. Many waterfall records may exist for a transaction like, for example: industry adjustments, sales discretion, shipping charges, shipping allowances, late payment costs, extended terms costs, consignment costs, returns, packaging costs, base material costs, additive costs, processing costs, variable costs, shortfalls, overages, and the like.

The analysis of the data may then automatically generate a transaction and policy database 308. For example, analysis of a selected group of transactions residing in a historical database may generate a policy that requires or suggests a rebate for any sale in a given region. In this example, some kind of logical conclusion or best guess forecast may have determined that a rebate in a given region tends to stimulate more and better sales. This policy is thus guided by historical sales transactions over a desired metric—in this case, sales by region. The policy may then be used to generate logic that will then generate a transaction item.

In this manner, a price list of one or many items reflecting a calculated rebate may be automatically conformed to a given policy and stored for use by a sales force, for example. In some embodiments, policies are derived strictly from historical data. In other embodiments, policies may be generated ad hoc in order to test effects on pricing based hypothetical scenarios. In still other examples, executive committee(s) 320, who implements policies, may manually enter any number of policies relevant to a going concern. In this manner, policies may be both automatically and manually generated and introduced into the system.

After transactions are generated based on policies, the transactional portion of the database may be used to generate sales quotes by a sales force 316 in SAP 312, for example. SAP may then generate a sales invoice which may then, in turn, be used to further populate a historical database 304, which closes the loop. In some embodiments, sales invoices may be constrained to sales quotes generated by a transaction and policy database. That is, as an example, a sales quote formulated by a sales force 316 may require one or several levels of approval based on variance (or some other criteria) from policies stored in a transaction and policy database 308. In other embodiments, sales invoices are not constrained to sales quotes generated by a transaction and policy database.

By applying closed-loop logic to a price modeling environment, pricing advantages may be achieved. In one example, workflow efficiencies may be realized where “successful” sales are tracked and policies supporting activities corresponding to the “successful” sales are implemented. The determination of “successful” in terms of a sale may be defined in any of a number of ways including, for example, increased profitability or volume. In this manner, an enterprise allows real market results to drive sales' policy rather than basing policy solely on theoretical abstractions. In other examples, hypothetical changes to policies may be tested. Thus, for example, a suggested policy requiring a rebate for any sale over $1000.00 may be implemented to test the effect on overall margins without actually modifying existing policies. In that case, a suggested policy change may reveal insight into future sales transactions that result in no net effect on margins, or may reveal insight into areas that require further adjustment to preserve or increase margins.

Another advantage to the system is that policy may flow directly from input data in an efficient manner. Individual spreadsheets and analysis typically used in price modeling may no longer be necessary. Instead, executive committees have access to real-time data that is continually updated to reflect current sales and sales practices. Response to a given policy may be seen or inferred directly from a historical database and implemented directly on a transaction and policy database. Thus, temporal efficiencies are achieved.

In still other examples, a closed-loop system may be used to evaluate individual or grouped transactions as, for example, in a deal making context. That is, a salesperson may generate a quote for a given customer and submit that quote for comparison against a policy formulated transaction in a transaction and policy database. A comparison may reveal some basis upon which a quote may represent a profitable deal. In some embodiments, a deal indicator may be generated. A deal indicator may be a ratio of the quote against a composite index that generates a value between 0 and 1 corresponding to profitability. In this example, a ratio returning unity (i.e., 1) indicates a deal is in conformance with established policy. It may be appreciated that a ratio may be defined in any of a number of manners without departing from the present invention.

In other embodiments, a deal suggestion may be generated. A deal suggestion may provide a range of acceptable (i.e., profitable) pricing based on quote parameters. Thus, a quote having deal specific set parameters like, for example, a fixed shipping price may return a range of allowable rebates or a range of allowable sales discretion that account for a fixed shipping input. In still other embodiments, deal guidance may be provided. Deal guidance provides non-numeric suggestion for a given quote. Thus, deal guidance might, for example, return “acceptable deal,” or “unacceptable deal” in response to a given quote. Policy considerations underlie deal indicators, deal suggestions, and deal guidance. Availability of these comparisons allows a user to select a comparison best fitted to their sales techniques and preferences which may result in sales efficiencies.

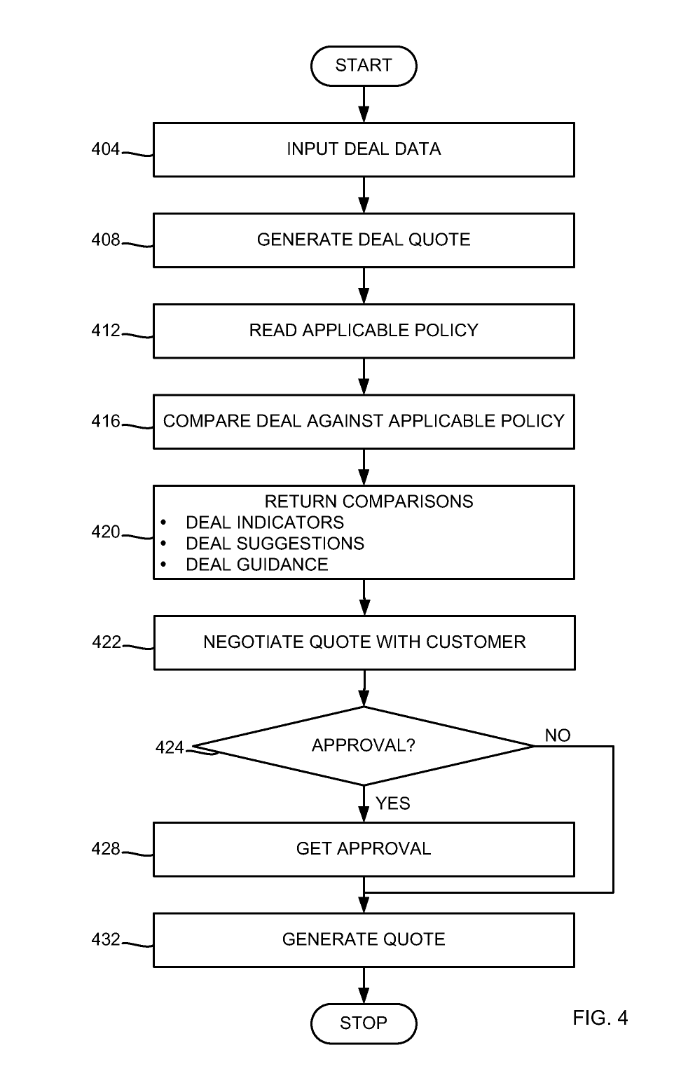

An example embodiment of the present invention using a closed-loop system is next presented. FIG. 4 is a flow chart of an embodiment of the present invention based on a closed-loop system. At a first step, 404 deal data is input into the system. Deal data may include any of a number of inputs like, for example, shipping costs, rebate, discounts, and the like. A deal quote may then be generated at a step 408 calculated from the deal data input at a step 404 and further including any missing field items based on policy considerations. Applicable policy is then read at a step 412. Applicable policy may be automatically selected or user selected by a particular metric. For example, policy may be utilized based on global metrics or may be delimited by region.

After the applicable policy is read at a step 412, a deal quote may then be compared against applicable policy at a step 416. As noted above, a comparison may reveal some basis upon which a quote may represent a profitable deal. Comparisons are then returned for review by a user at a step 420. As noted above, comparisons may include deal indicators, deal suggestions, and deal guidance. An advantage of returning a comparison is that a complex analysis may be reduced to a readily ascertainable form. In this case, a deal indicator may return a ratio; a deal suggestion may return an acceptable range of values; and deal guidance may return a non-numeric suggestion for a given deal. Thus, a deal maker may determine, at a glance, the acceptability based on policy of a given quote.

Once comparisons are returned at a step 420, a quote may be negotiated at a step 422 that may or may not incorporate any or all of those corresponding comparisons. In this manner, a salesperson negotiating a deal may flexibly structure a deal with confidence that the deal may be constrained to comparison parameters resulting in a profitable deal for an enterprise. In one embodiment, entering a negotiated transaction initiates a recalculation of comparisons. Thus, a deal maker may view real-time changes to a deal structure as a deal is being formed. This feature is particularly useful in that final negotiating point parameters may be expanded or contracted as a deal progresses providing a deal maker with an increasingly better defined negotiating position.

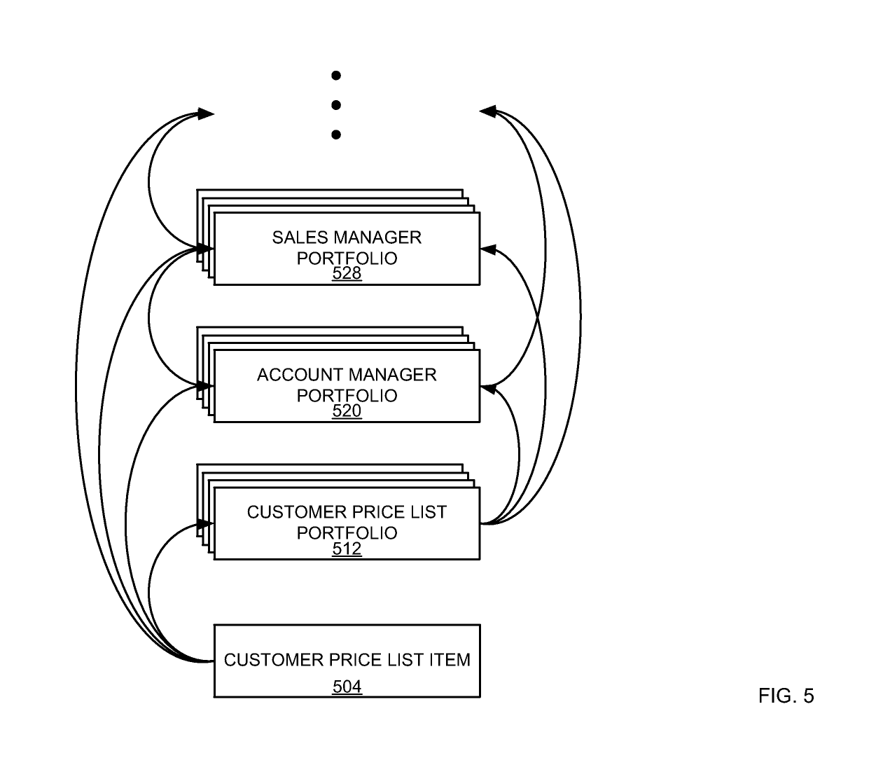

After a quote negotiation is complete at a step 422, the method determines whether approval is needed at a step 424. Approval, in this context, may be coupled with a portfolio manager. A portfolio manager may be utilized in an embodiment of the present invention to efficiently expedite approval of pending deals. Approval may include one or more levels depending on variance from an explicit or implicit policy. That is, for a particular deal that greatly varies from a policy, higher authority must approve of that particular deal. For example, a deal offering a rebate that is within policy limits may not require approval while a similar deal offering a rebate that falls outside of policy limits by, for example, 25% may need a sales manager or higher approval. Approval may be linked upward requiring executive officer approval in some cases. Portfolio management will be discussed in further detail below for FIG. 5.

If approval is needed, then a deal must be approved at a step 428. The method then continues at a step 432 to generate a quote. If approval at a step 428 is not needed, the method continues at a step 432 to generate a quote. As can be appreciated, a quote may then be used to generate an invoice. However, an invoice may or may not match the quote upon which it is based. Rather, an invoice represents an actual sale. It is the data from an actual sale that continues to populate a historical database. The method then ends.

As noted above, a portfolio manager may efficiently expedite approval of pending deals. Enterprises, as a practical reality, have a mix of “good” and “bad” deals—good deals being defined as profitable. Evaluating deals in isolation may not maximize profits at an enterprise level. For example, industries having large fixed costs may accept a number of high volume “bad” deals in order to capture a number of low volume “good” deals resulting in an overall profit. Industries evaluating deals in isolation may not realize this benefit and thus may not be able to survive. Portfolio organization, therefore, assists, for example, sales managers maximize profitability for an enterprise by allowing those managers to view enterprise level effects of a deal or groups of deals.

As seen in FIG. 5, a schematic representation of a portfolio hierarchy in accordance with an embodiment of the present invention is provided. A customer price list item 504 exists at the root of the hierarchy as an item. Each item may be configured to require approval on a pending deal, or may be configured to ignore approval on a pending deal. The customer price list item 504 may contain any of a number of descriptive and/or numeric terms such as price, description, availability, etc., for example. In one example, customer price list items 504 may be grouped into a portfolio known as customer price list portfolio 512.

Customer price list portfolios comprise customer price list items grouped according to a desired criteria or criterion. For example, price lists may be organized by cost, by type, by distributor, by region, by function, and by any other selected parameter. In this manner, approval, as an example, for a group of items—items under $1.00 for example—may be required or ignored. By grouping items, approval processes may be retained only for selected key products. In one embodiment, one or more criteria may be utilized to organize customer price list portfolio. It can further be appreciated that many other combinations of groupings for portfolios are possible. Thus, for example, a sales manager portfolio may comprise: customer price list items 504; customer price list portfolios 512; or account manager portfolios 520 as indicated by multiple arrows in FIG. 5. Further, in this example, a customer price list portfolio 512 is a static portfolio. That is, a static portfolio does not change according to a formula or algorithm. Rather, a static portfolio is entered and modified manually. It may be appreciated that most, if not all, portfolios may either be static portfolios or dynamic portfolios.

Customer price list portfolios 512 may then be organized to generate an account manager portfolio 520. Account manager portfolios 520, in this example, comprise customer price list portfolios 512 grouped according to a desired criteria or criterion. Typically, accounts may be organized by named companies or individuals. In addition to organizing accounts by name, accounts may be organized by approval. That is, all approval accounts may be managed singly or in group thus facilitating policy implementation. For example, an account portfolio may be organized such that any account having a 12-month history of on-time transactions no longer needs approval so that approval is ignored. In this way, an on-time account may accrue a benefit of an expedited approval thus making transactions more efficient for both the sales person and the account. Further, in this example, an account manager portfolio is of the type—static portfolio. As noted above, a static portfolio does not automatically change according to a formula or algorithm.

Account portfolios 520 may be further organized to generate sales manager portfolios 528. Sales manager portfolios 528, in this example, comprise account manager portfolios 520 grouped according to a desired criteria or criterion. Typically, sales manager portfolios may be organized by named individuals or groups of individuals. In addition to organizing sales manager portfolios by name, sales manager portfolios may be organized by approval. As noted above, approval based portfolios may be managed singly or in group thus facilitating policy implementation. For example, a sales manager portfolio may be organized such that sales people with seniority no longer need approval for deals under a capped amount. In this way, sales people with more experience benefit from an expedited approval process since presumably more experienced sales people have a deeper understanding of company policies and priorities. In addition, as new policy is generated, approvals may be reinstated as a training measure so that policies may more effectively be incorporated into a workflow. In this example, a sales manager portfolio 528 is of the type—dynamic portfolio. Dynamic portfolios may be generated according to formula or algorithm. For example, a sales manager portfolio may be generated for all sales associates whose total billing exceeds a desired dollar amount. In this way, managers may creatively and efficiently differentiate productive and unproductive sales associates and may further apply varying levels of approval.

### II. Enterprise Pricing System

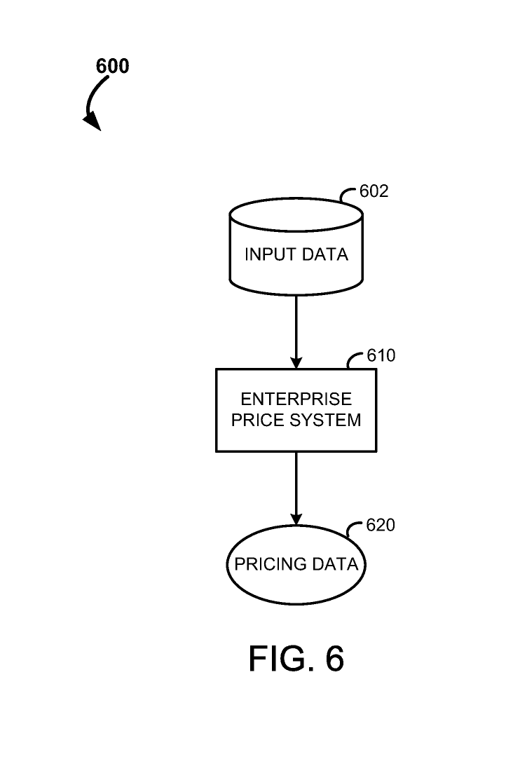

Now that the general structure of an example enterprise environment has been discussed, attention will now be focused upon the systems for pricing that incorporate price protection and price caps. To facilitate this discussion, attention is directed toward FIG. 6 where an example block diagram of the system 600 for managing pricing is provided.

The enterprise price system 610 receives information from an input data source 602. This input data typically includes prior transaction data, price listings, policy guidance and the like. The enterprise price system 610 can leverage this input data 602 to generate pricing data 620. Periodically, pricing data 620 may be updated in response to external cost changes and according to contractual terms. Likewise, the input database 602 may be updated by the enterprise price system 610 when new policy information is generated, new transaction data is available, etc.

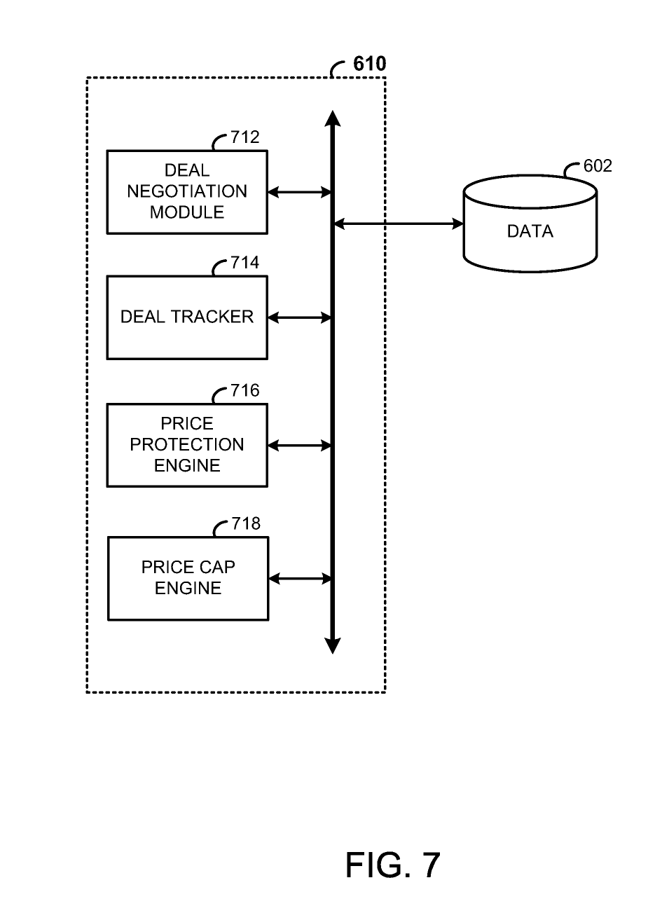

FIG. 7 provides a more detailed illustration of the enterprise price system 610. This system is seen as including multiple subsystems coupled to one another via a central bus. These subsystems may be physically separate devices, or may be integrated into the same physical device, and are merely illustrated separately due to their logical functionality.

The enterprise price system 610 is comprised of a deal negotiation module 712, a deal tracker 714, a price protection engine 716, and a price cap engine 718. The negotiation module 712 utilizes list price data and policy considerations found in the data 602, to assist a sales representative negotiate a deal scenario, as discussed previously. Once the deal has been negotiated and agreed upon, the deal tracker 714 is able to monitor the deal. Factors that may impact the deal are reviewed by the deal tracker 714, and may be applied to the deal invoices if they are in compliance with the deal's terms. Some of these factors, which involve changes in prices, may be first fed through the price protection engine 716 and price cap engine 718 in order to ensure that any price changes are implemented in a compliant manner.

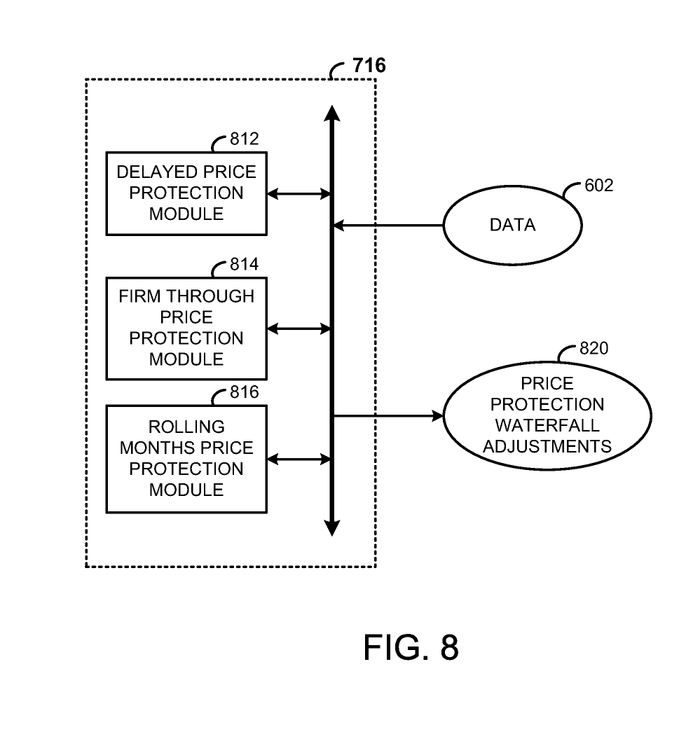

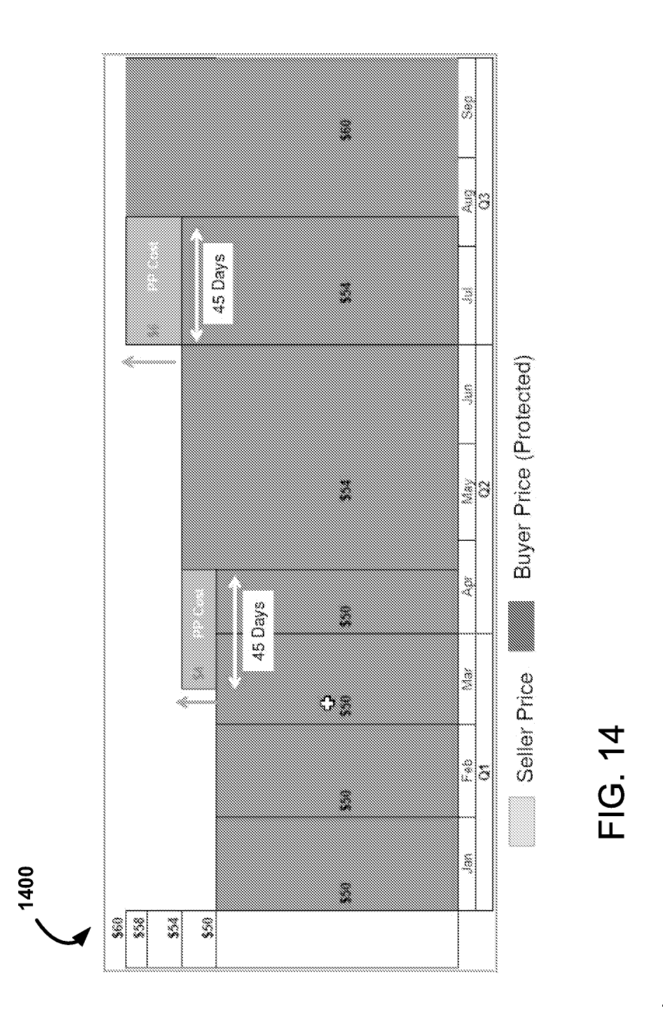

FIG. 8 provides a more detailed example diagram of some embodiment of the price protection engine 716. This example embodiment includes three sub-modules: delayed price protection module 812, firm-through price protection module 814, and rolling months price protection module 816. Each of these modules implements a different manner of pricing protection. For example, turning to FIG. 14, a diagram 1400 is provided where a delayed pricing protection is in effect. In this example, a net forty-five day period expires between a price change for the seller, and the protected price of the buyer.

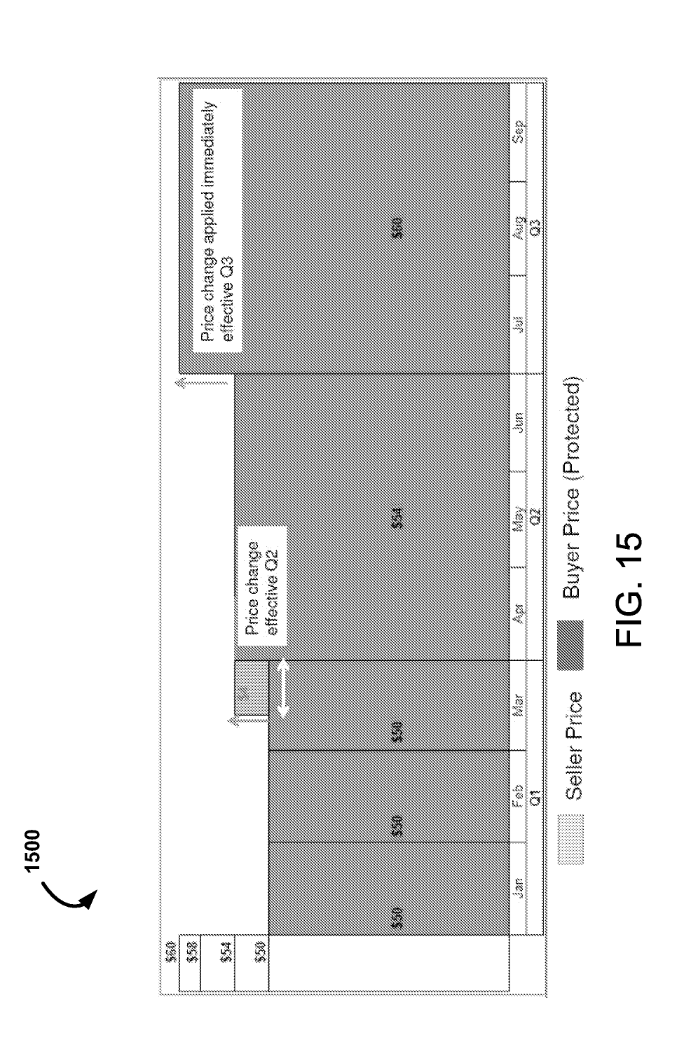

In contrast, FIG. 15 provides a diagram 1500 of a firm-through pricing protection model. In this specific example, the price is firm through the end of each quarter. Thus, a price change at some point in Q1 only becomes effective at the beginning of Q2. However, a price change at the very end of Q3 becomes effective immediately.

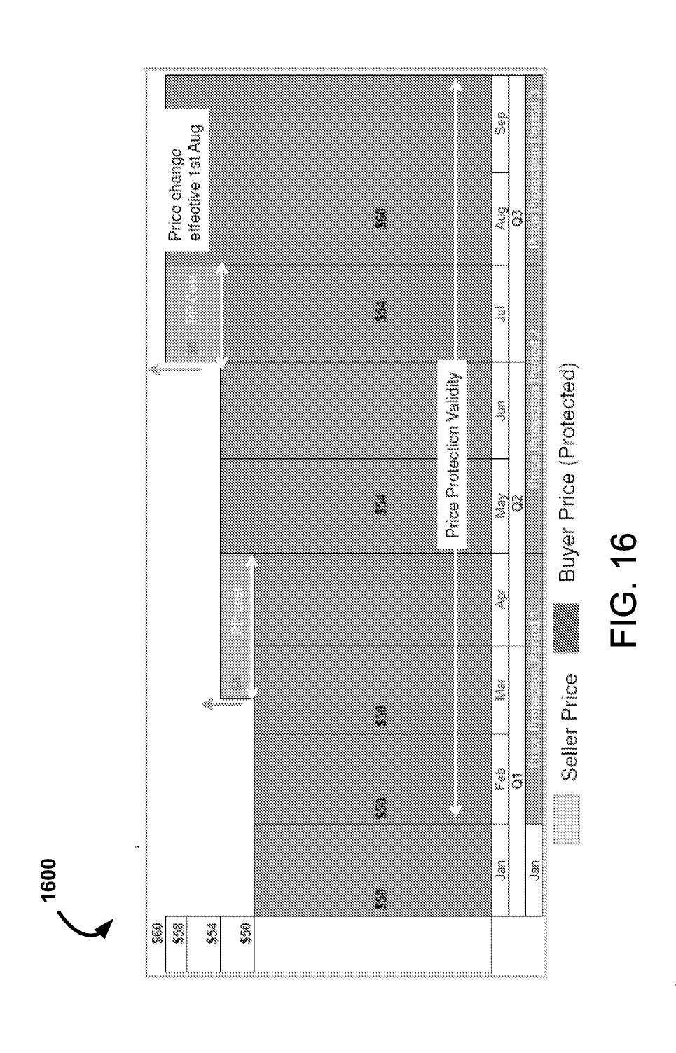

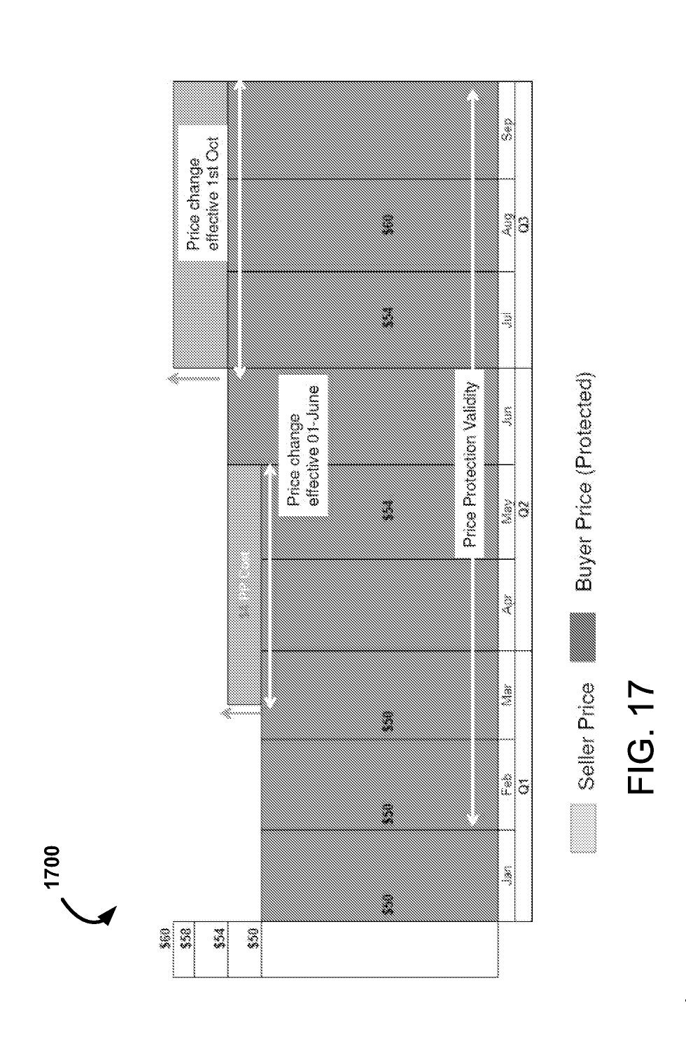

Lastly, FIG. 16 provides a diagram 1600 of a rolling price protection model. In this specific example, the price protection is on a rolling 3-month basis starting on February 1^{st}. Therefore, whenever a change is made, it does not go into effect until the end of the three month period. Another form of rolling price protection is delayed from the point of the price change. FIG. 17 provides an example diagram 1700 of such a rolling-delayed price protection. In this specific example, a three month rolling period triggers, starting in the month that the price increased. Thus, a buyer may receive up to 3 full months of price protection (if the price change occurs on the first of the month), or as little as two months and one day of price protection (if the change occurs on the last day of the month).

Returning to FIG. 8, the resulting adjustments to prices made by each of the modules is output as a price protection waterfall 820. This waterfall includes price protection adjustments for deals in order to ensure deals stay in compliance with their terms, and also can be utilized to preview the impact of a price protection term before it is implemented.

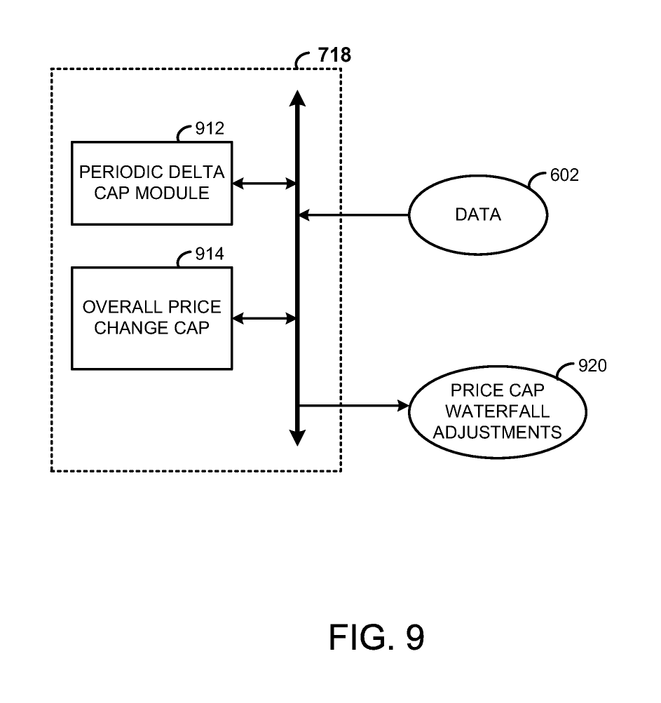

Continuing, FIG. 9 provides a more detailed example of the price cap engine 718, which includes a pair of logical modules, each coupled together. The first is a periodic delta cap module 912 which allows a particular frequency of price changes and/or regulates the amount of price change per given time period. Likewise, an overall price change cap module 914 may set limits upon the total price change possible over a term.

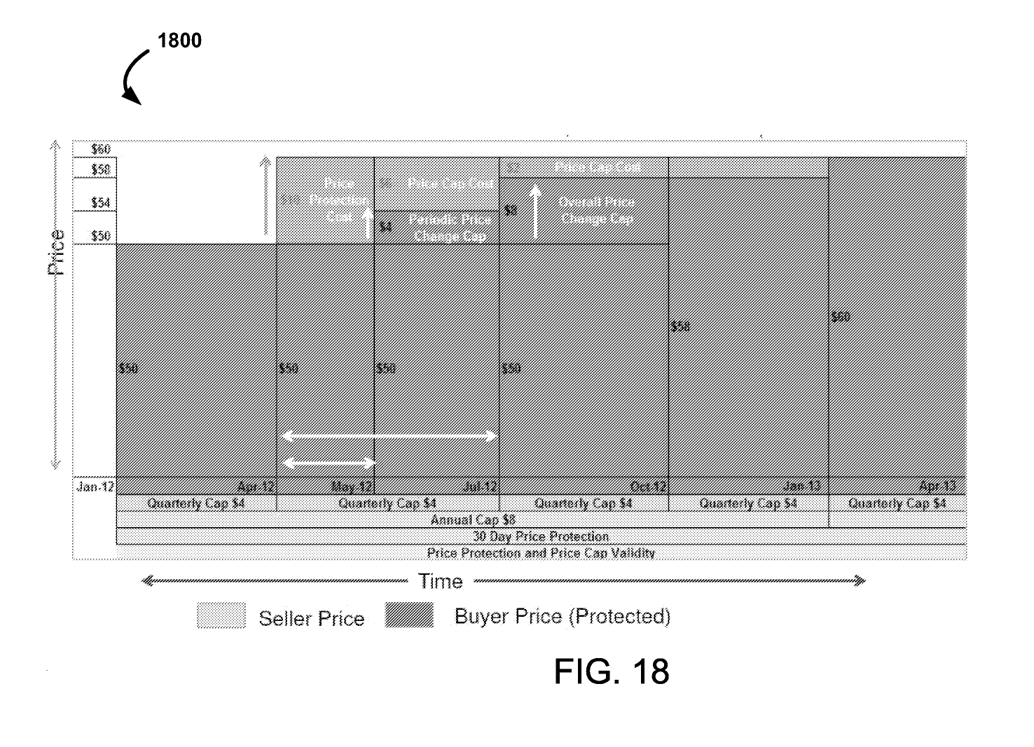

Like with price protection, the price cap engine 718 outputs a price cap waterfall adjustment 920 in order to ensure deals stay in compliance with their terms, and also can be utilized to preview the impact of a price cap term before it is implemented. By way of example, FIG. 18 provides a diagram 1800 of a price cap scheme where the total price change is limited to an increase of $8 over an annual basis, a quarterly cap of $4, and a thirty day price protection term. Thus, while the seller may experience a ten dollar increase in price, the first increase is delayed by thirty days and is limited to $4. At the beginning of the next quarter the price may increase again by $4. Now, however, the annual cap of $8 has been met, and no additional increases may occur until the beginning of the following year.

As can be seen, the utilization of one or more price protection and price cap terms my hedge buyers from sudden price increases, and may hedge price fluctuation risk. These are important, and highly competitive, terms that often determine a buyer's willingness to accept a deal. Likewise, their impact on the deal is often not well understood, and improper compliance is a major source of leakage. By utilizing these enterprise pricing systems with price protection and price cap engines, leakage due to protection and cap compliance are minimized. Further, as previously mentioned, the impact of these terms may be previewed in order to assist in the formation of a deal.

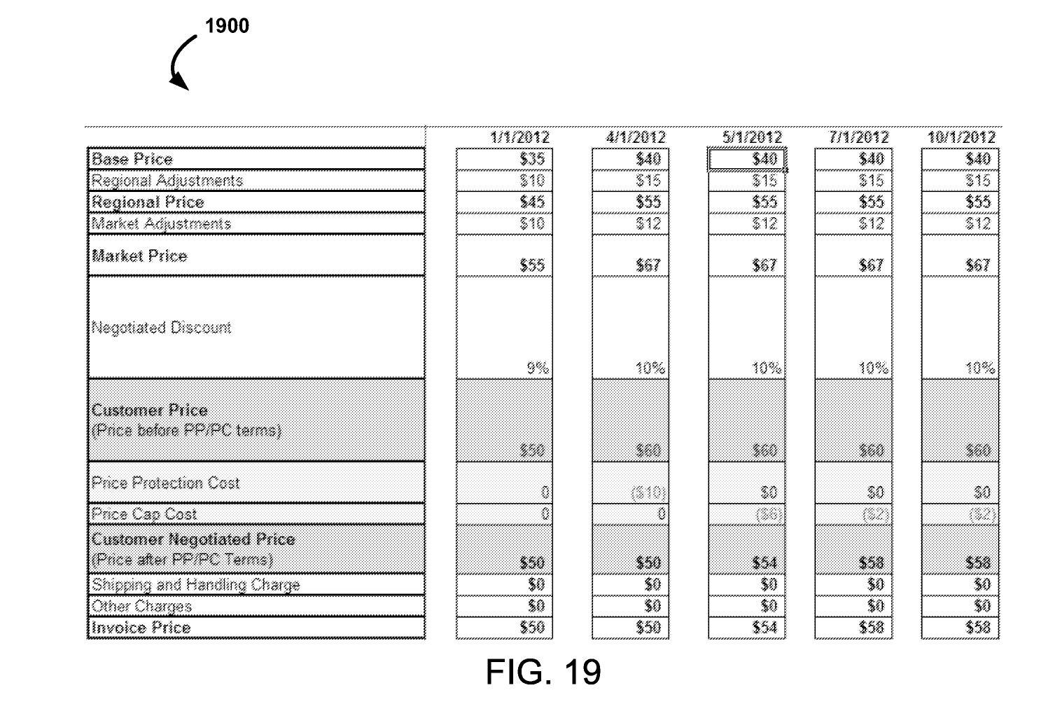

FIG. 19 provides a waterfall 1900 that includes a price protection cost and price cap cost. Price protection and price cap terms are negotiated against a given price point that is negotiated with the buyer in a price agreement in the deal manager/enterprise pricing system. Each of these terms have cost implication to the seller referred to as price protection cost and price cap cost. To enable price protection and price cap, the waterfall needs to include the price points and price adjustments related to price protection and price cap. For example, the waterfall may include a price point which reflects the buyer price with the effect of Price Protection and Price Cap costs on the seller offered customer price. Secondly, the waterfall should include the one or two price adjustments attributable to price protection and price caps.

The waterfall shown in FIG. 19 mirrors the scenario discussed in FIG. 18. Initially, there is a price protection cost of $10 directly after the price increase. After thirty days this cost expires, however, the price cap cost is still $6 (since the price was able to increase $4 in that quarter). Next quarter the price increases an additional $4, but is capped beyond this amount. Therefore, the price cap cost is $2.

A general set of rules can be utilized to generate the price protection adjustment within the waterfall. These include the price protection cost is equal to post-protection price minus the pre-protection price. The pre-protection price is the price that the seller will charge the buyer if there were not price protection terms, and the post-protection price is the price that the buyer will pay, after enforcing the price protection terms. Pre-protection price and post-protection price correspond to the waterfall price point that is protected by price protection terms. A price point that is protected may differ from project to project. For example, some projects can protect ‘Customer Price’ on the deal while other projects may decide to protect ‘Market Price’. Protecting ‘Customer Price’ on the deal is the most common usage.

Accordingly, a waterfall representation will list the pre-protection price, followed by the price protection and cap adjustments, followed by the post-protection price. The pre-protection price can be edited directly on the deal (as an independent price) or it can sometimes be the calculated price point that is dependent on other price points and adjustments. For example, in the following scenario, Customer Price may be a user-edited field on the deal or it can be a calculated field on the deal that is dependent on Market Price and other adjustments between Market Price and Customer Price.

If the pre-protection price is editable, the price can change through one of the following actions: a user manually changes price for a given line item within a deal; a user uses ‘Mass Edit’ to change prices across multiple line items within a deal; or a user uses ‘Mass Price Change’ to change price across multiple deals. If the pre-protection price point is a calculated price (that is dependent on other factors), then price can also change as a result of re-pricing the deal/line item. Subsequently, if the product has price protection terms in a deal, the terms will be enforced when there is a price change on a deal for a given time period. Terms are enforced on the deal when the line item is in “Revising” status or when the line item is “Renewed” to carry forward terms, in some embodiments. Price protection terms will delay the price change to the buyer for the duration of price protection, as previously discussed.

In some specific embodiments, price change is identified by comparing the pre-protection price in a revision for the selected period against the last approved pre-protection price for the same period. Different time periods can have different prices for the same product within a deal. Price protection cost is calculated for each time period for a given product/line item of the deal.

For a given price change, the price change may need to be delayed across multiple periods to fully enforce price protection terms. This can happen when the duration of a given time period is shorter than the price protection delay period. E.g. there is a price change effective March 15 and product has 30 day price protection. If there is an existing time period with effective period between March 15 and March 31, then the time period is not sufficient to enforce the price protection terms fully and price change delay needs to be carried forward to the next period. If the price change is for a very short duration (shorter than the price protection duration), then the buyer with price protection may not get impacted by the price change at all. E.g. if the price change applies only for a 15 day period (e.g., Thanksgiving discount), but the buyer has 30 day price protection, buyer will not be impacted by the price change at all. Likewise, if there are consecutive price changes that are applicable for short durations (shorter than price protection delay), these price changes may not get passed to the buyer. Only price changes that will impact the buyer are the price changes that will remain effective for duration greater than the price protection duration.

In some cases the price change passes directly to the consumer immediately. These occur if the user overrides the price protection terms, if the price change is applied effective from the first day of the price protection period in case of “Firm Through” price protection type, and if the price protection needs to be enforced for only “Price Increase” and price change results in price reduction.

Similar to price protection, a general set of rules can be utilized to generate the price cap adjustment within the waterfall. These rules require that a price cap validity date range is defined, cap periods, periodic price increase/decrease caps, overall price cap period, and overall price increase/decrease caps. This allows for tiered price capping (say a change of $10 per month, but limited to a change of $20 per quarter, for example).

For overall price caps, irrespective of the number of times price changes during the year and irrespective of the amount of price change, maximum and minimum price for each period will be limited by maximum and minimum calculated limits. For the recurring overall cap such as annual cap, the calculation of “maximum and minimum price” for the consecutive periods is based on the ending “maximum and minimum price” for the previous period. For example, if baseline is $40 effective Jan. 1, 2012 to Dec. 31, 2013. Buyer negotiates Price Cap terms of +/−$2 Quarterly Cap and +/−$6 Annual Cap the maximum price for two years is calculated as: Q1−12=$42, Q2−12=$44, Q3−12=$46, Q4−12=$46, Q1−13=$48, Q2−13=$50, Q3−13=$52, Q4−13=$52. Likewise, the minimum price over two years is calculated as: Q1−12=$38, Q2−12=$36, Q3−12=$34, Q4−12=$34, Q1−13=$32, Q2−13=$30, Q3−13=$28, Q4−13=$28. If there are no periodic caps but only overall cap terms, then maximum and minimum price limits are calculated only based on overall cap limits

If the baseline period for 2012 and 2013 was different to begin with (due to agreed-upon terms, for example) then the maximum and minimum price limits for the 2013 will be based on baseline price at the beginning of 2013. For example, if baseline is $40 effective Jan. 1, 2012 to Dec. 31, 2012 and $45 effective Jan. 1, 2012 to Dec. 31, 2012. Buyer negotiates Price Cap terms of +/−$2 Quarterly Cap and +/−$6 Annual Cap the maximum price for two years is calculated as Q1−12=$42, Q2−12=$44, Q3−12=$46, Q4−12=$46, Q1−13=$47, Q2−13=$49, Q3−13=$51, Q4−13=$51. Likewise, the minimum price over the two years is calculated as Q1−12=$38, Q2−12=$36, Q3−12=$34, Q4−12=$34, Q1−13=$43, Q2−13=$41, Q3−13=$39, Q4−13=$39.

Baseline price to calculate maximum and minimum price for each period can change if the seller does a price change by overriding the price cap terms, price cap terms are re-negotiated (edited), and/or when agreement is renewed. In some embodiments, an overridden price will be used as baseline only in the next revision once the current revision in which price is overridden is approved. For example, if the seller makes a price change to $50 effective Q2 by overriding the price cap terms, then $40 will be the baseline price for Q1 and $50 will be the new baseline price from Q2−Q4.

In some embodiments, when the terms are re-negotiated/edited (in a given revision of the agreement), terms are enforced effective the next revision of the agreement (once the new terms are approved). There is no change in the base-line price used to calculate the maximum/minimum cap limits in this case.

In some embodiments, when the agreement is renewed, baseline price from the original agreement (at the time when agreement is renewed) is used as the new baseline price to calculate the maximum and minimum price change limits. Maximum and minimum price limits for the new renewed agreements Price cap periods will be calculated assuming the new periods are continuation of the original agreement time periods. Accordingly, all the rules that apply for baseline, maximum and minimum price limits for original agreement applies to the renewed agreements also.

Moreover, in some embodiments, if the entire price change cannot be passed to the customer during the validity of a given agreement, then price change is passed to the customer in the new agreement when the original agreement is renewed.

### III. Methods of Price Protection and Price Cap

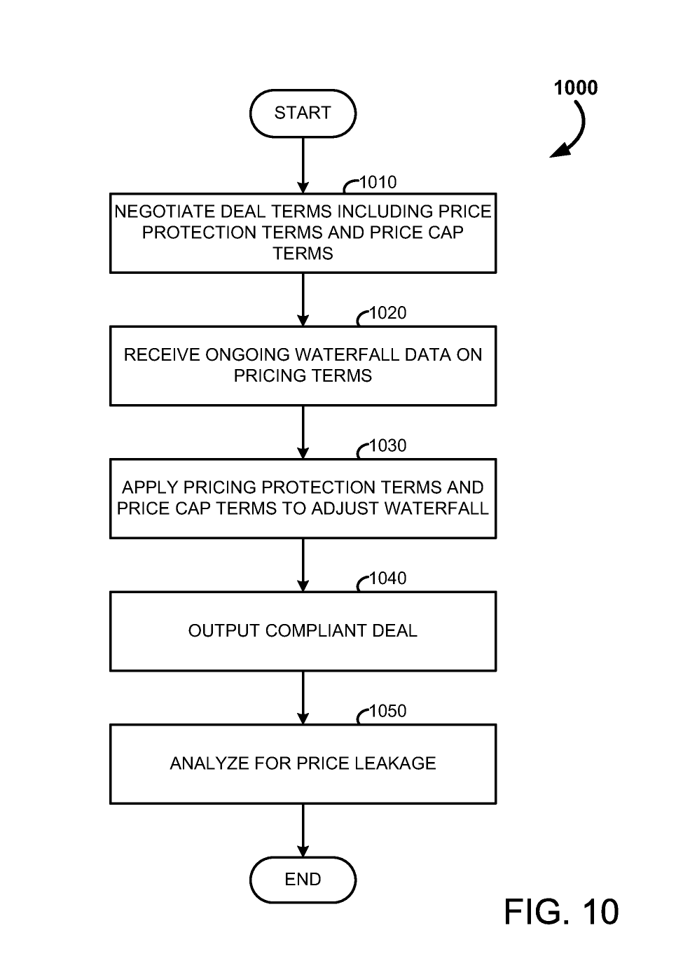

To further facilitate the discussion of some embodiments, attention will be turned to FIG. 10, which provides a high level flowchart 1000 for the method of price management with price protection and price caps. In this example, deal terms are negotiated (at 1010) which includes negotiating price protection terms and price cap terms. As previously mentioned, in some embodiments, the price protection and cap terms may be previewed on historical datasets to illustrate the impact these terms may have upon the current deal.

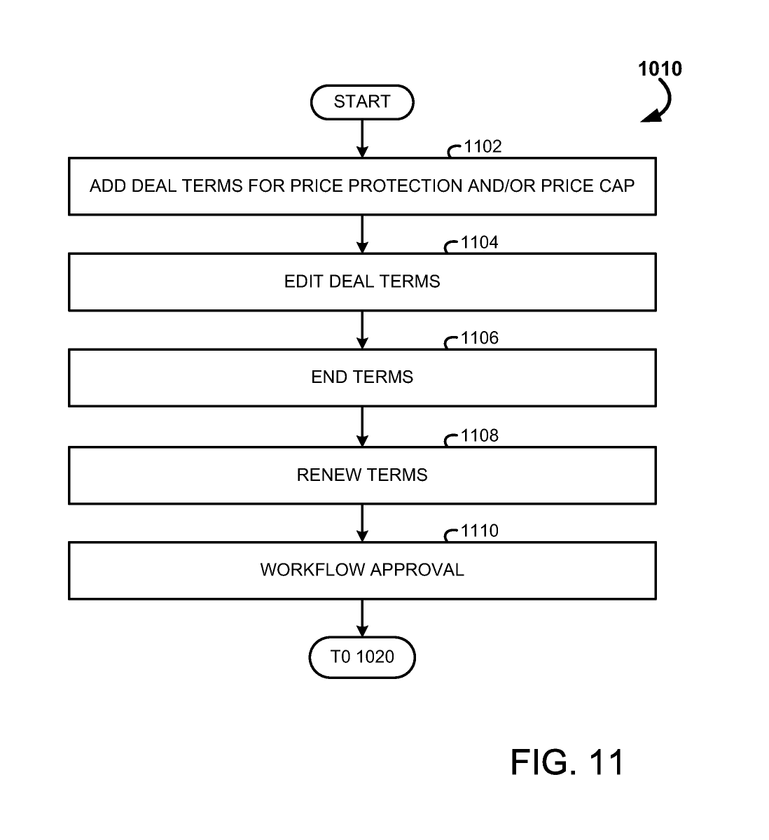

FIG. 11 provides a more detailed flowchart for the method of negotiating the deal, seen generally at 1010. In this example method, the deal terms are added for price protection and/or price caps (at 1102). Additionally, the deal terms may be edited (at 1104), terminated (at 1106) or renewed (at 1108). Where necessary, approvals may be secured (at 1110) for the new set of terms. Approvals may be required when deal terms deviate from established policies, as disclosed in the previous sections.

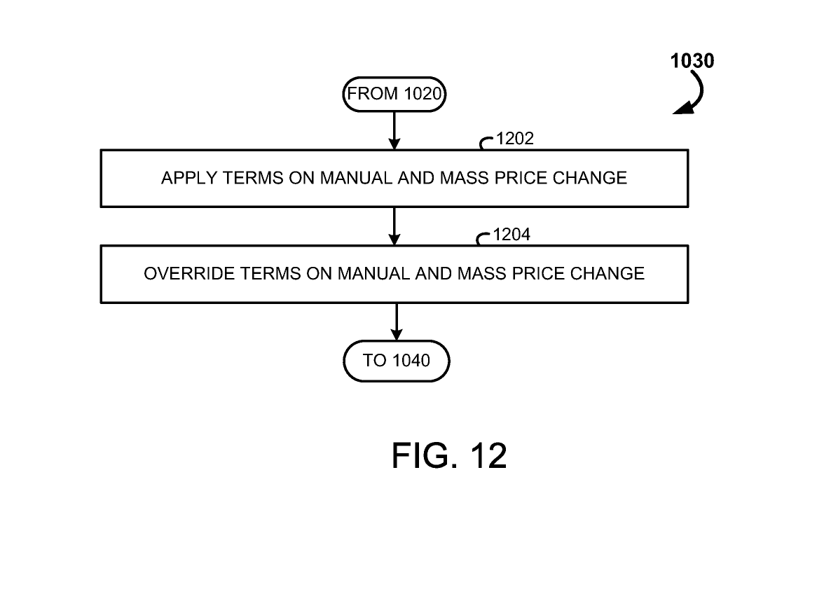

Returning to FIG. 10, after the negotiation and setting of deal terms, ongoing waterfall data on the pricing terms is received (at 1020). Next, pricing term adjustments may be made to the waterfall (at 1030). FIG. 12 provides a more detailed illustration of a flowchart for the adjustment process, seen generally at 1030. In this method, terms are applied (adjustments made) to manual and mass price changes (at 1202). These adjustments may then be overridden (at 1204) by a user, if desired. Overrides may, in some embodiments, require elevated approval in order to be completed.

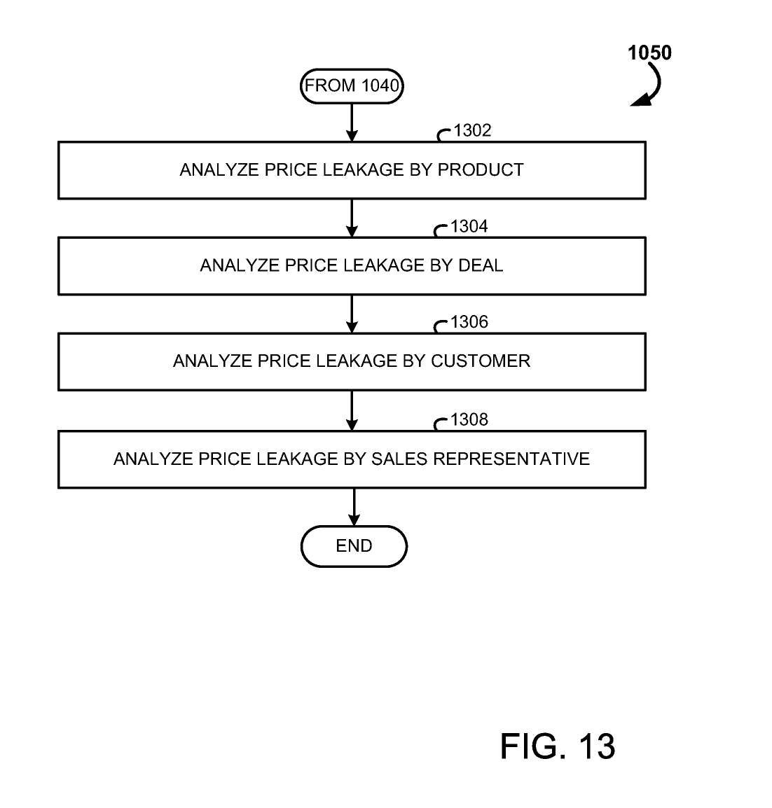

Returning to FIG. 10, after applying the price cap and protection adjustments, the method may output a compliant deal (at 1040). The deal is then analyzed for leakage (at 1050) to ensure maximal profitability under the given set of terms. FIG. 13 provides a more detailed flowchart of the process of leakage analysis. In this example process, leakage is analyzed for at product levels (at 1302), at the deal level (at 1304), by customer (at 1306) and by sales representative (at 1308). By analyzing for leakage on each of these dimensions, opportunities can be identified. For example, if a particular deal experiences higher than anticipated leakage, then the deal may warrant closer review to ensure these leakages are minimized. Likewise, if a particular sales representative has higher leakage, this representative may require additional training and review of deal terms.

Leakage analysis may be used to generate or refine polices that may be stored for future deal negotiations. After leakage is analyzed, the process ends. In addition to leakage analysis, the process may continue to actively review the deal invoices and ensure compliance with the price protection and price cap terms.

### IV. Examples

Now that the system architecture and processes have been disclosed in considerable detail, example screenshots shall be provided to help illustrate the process using relevant data for clarification purposes.

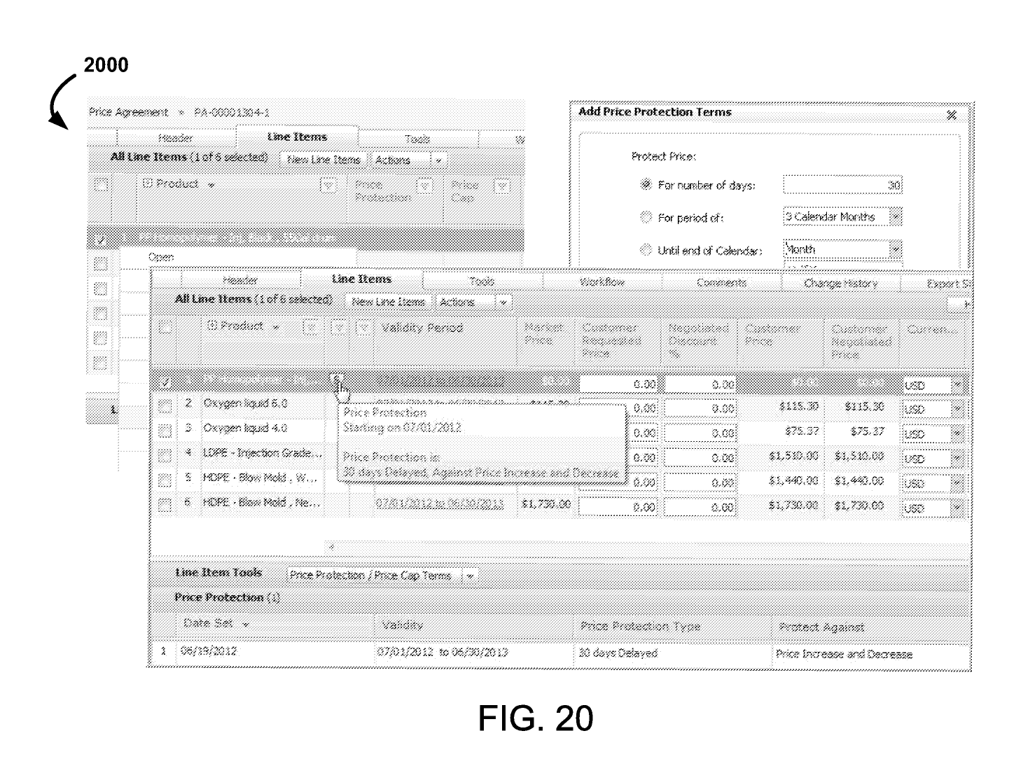

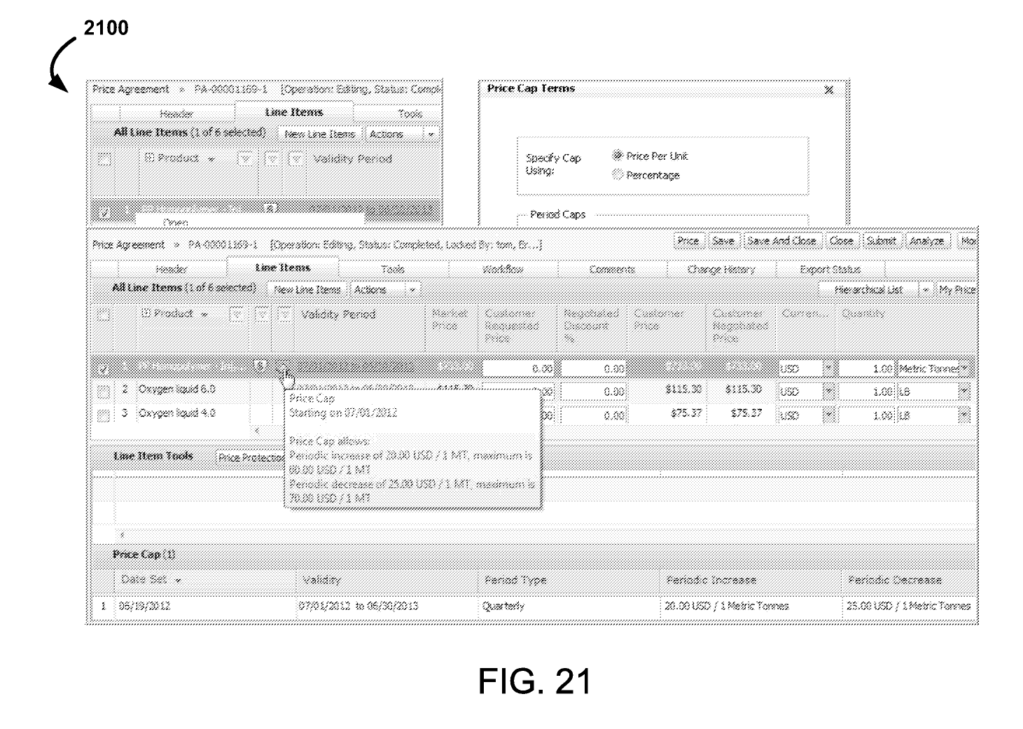

FIG. 20 provides an example screenshot 2000 of an enterprise pricing system interface for the addition of price protection terms. Likewise, FIG. 21 provides an example screenshot 2100 of an enterprise pricing system interface for the addition of price cap terms. These terms are typically determined during a deal negotiation, and as noted, may have substantial impact upon overall deal profitability.

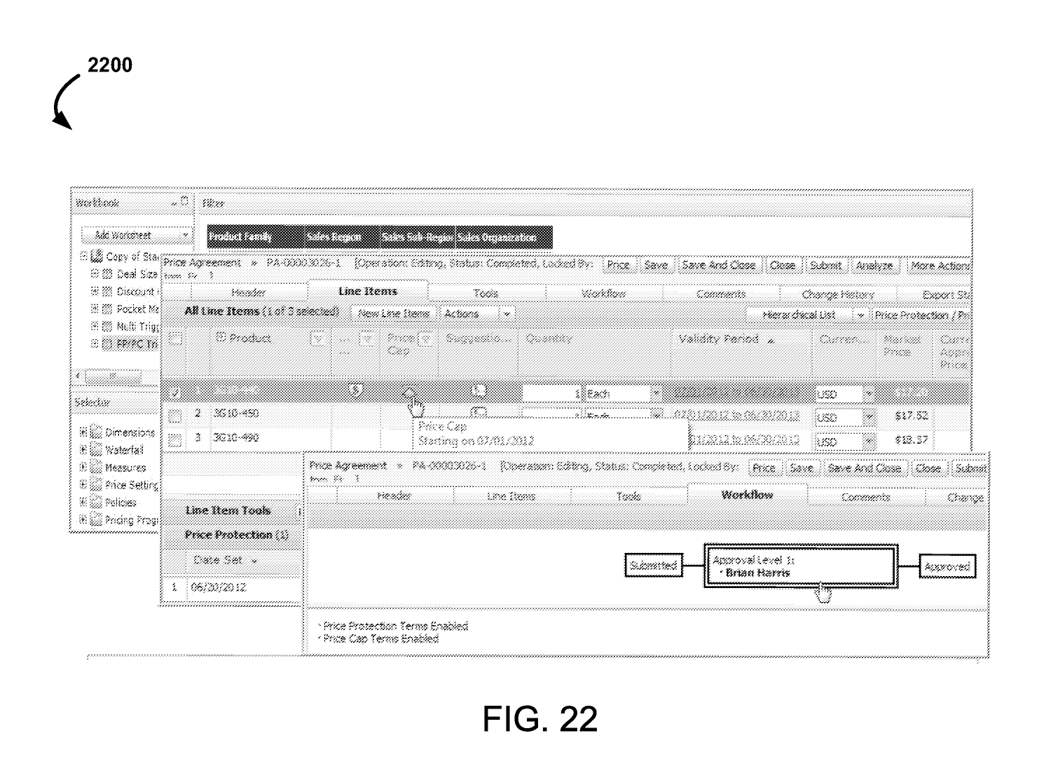

FIG. 22 provides an example screenshot 2200 of an enterprise pricing system interface where a workflow is presented. The workflow is enabled based on the price protection and price cap terms. This allows for enforcement of process controls (such as approval elevation) to negotiate better deals (more closely aligned to policies).

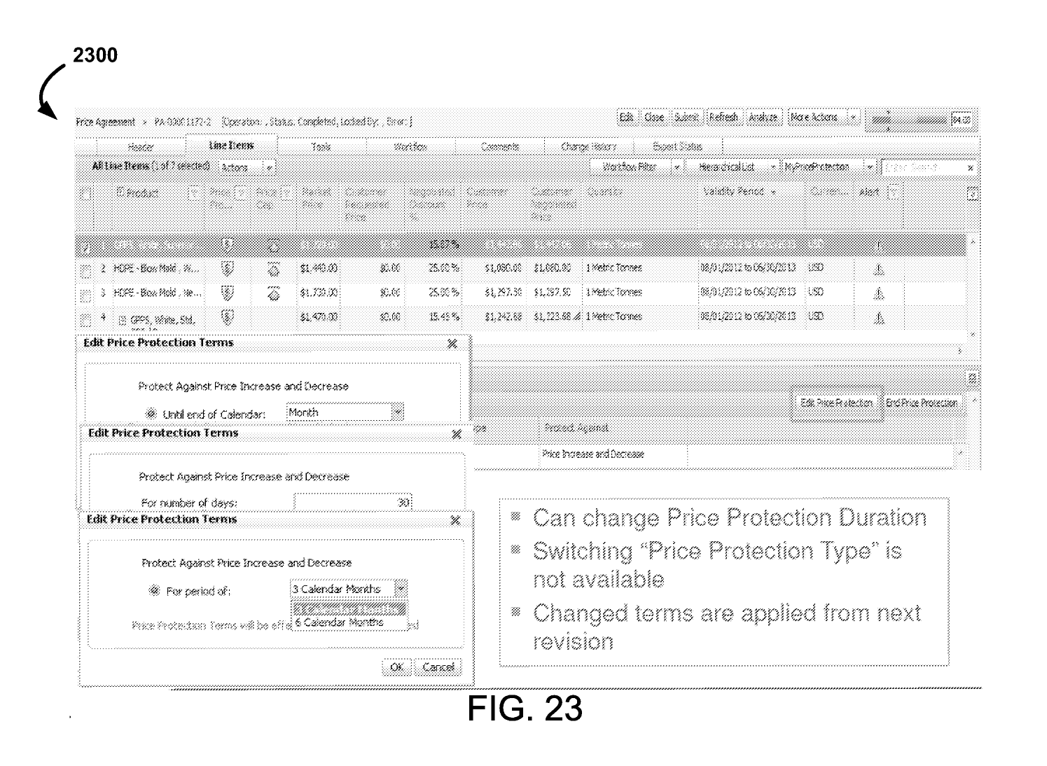

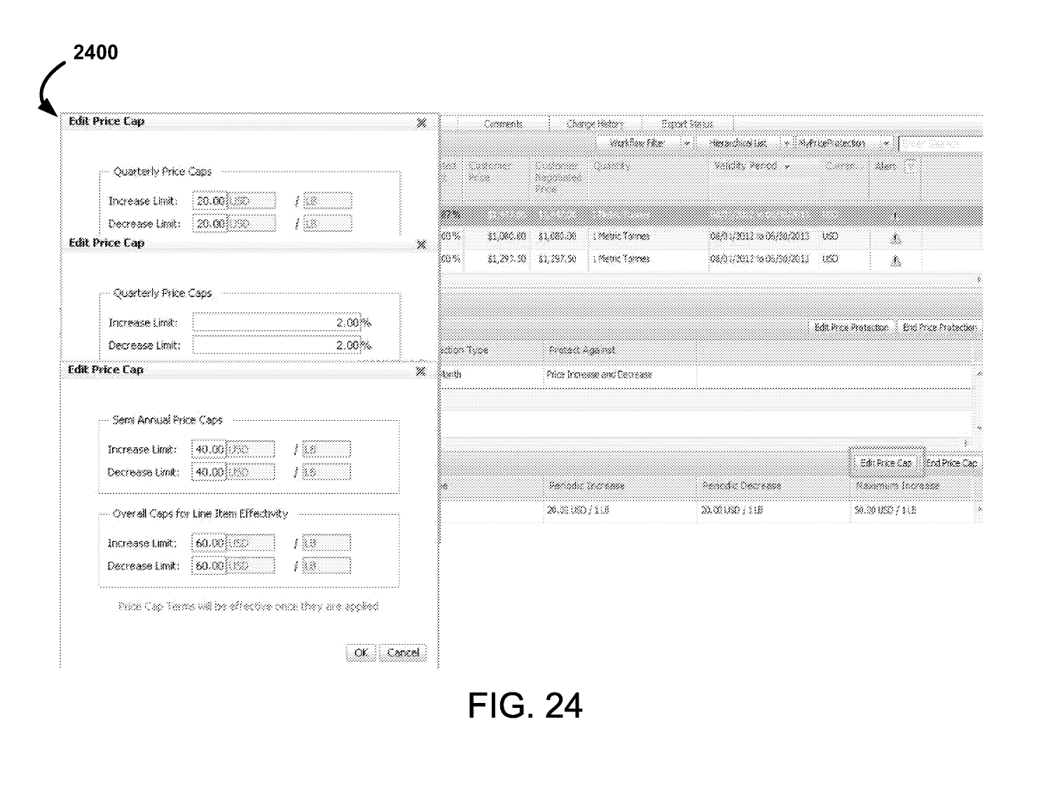

FIG. 23 provides an example screenshot 2300 of an enterprise pricing system interface where the price protection term is being edited. In this example, duration can be altered. Additionally, in some embodiments, it may also be possible to alter the type of price protection (i.e., rolling, delayed or firm-through). Likewise, FIG. 24 provides an example screenshot 2400 of an enterprise pricing system interface where the price cap term is being edited. This allows for the editing of price cap limits, and in some embodiments, it may also be possible to alter the type of price cap (i.e., periodic or overall). Terms that are altered via either of these editing screens may be applied to the next revision.

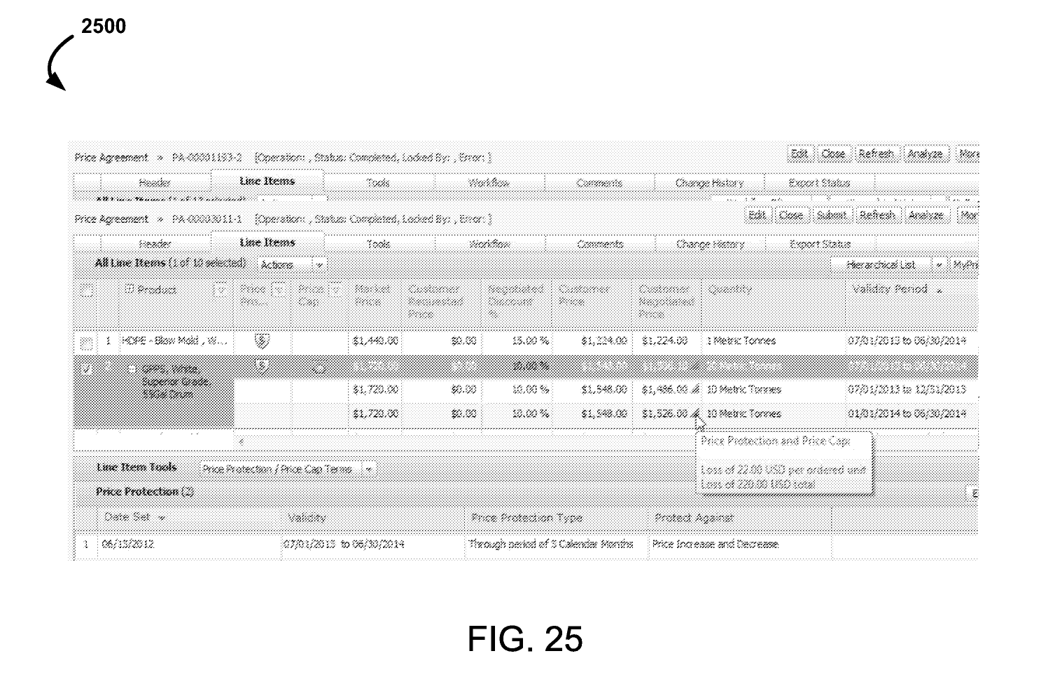

FIG. 25 provides an example screenshot 2500 of an enterprise pricing system interface where the agreement is renewed. A configuration option of the enterprise pricing system may enable the ability to carry forward price protection and price cap terms upon a renewal. Residual price changes from previous agreements are applied in the renewed agreement, and the price protection and price cap terms are enforced. The term details may be logged in the agreement history.

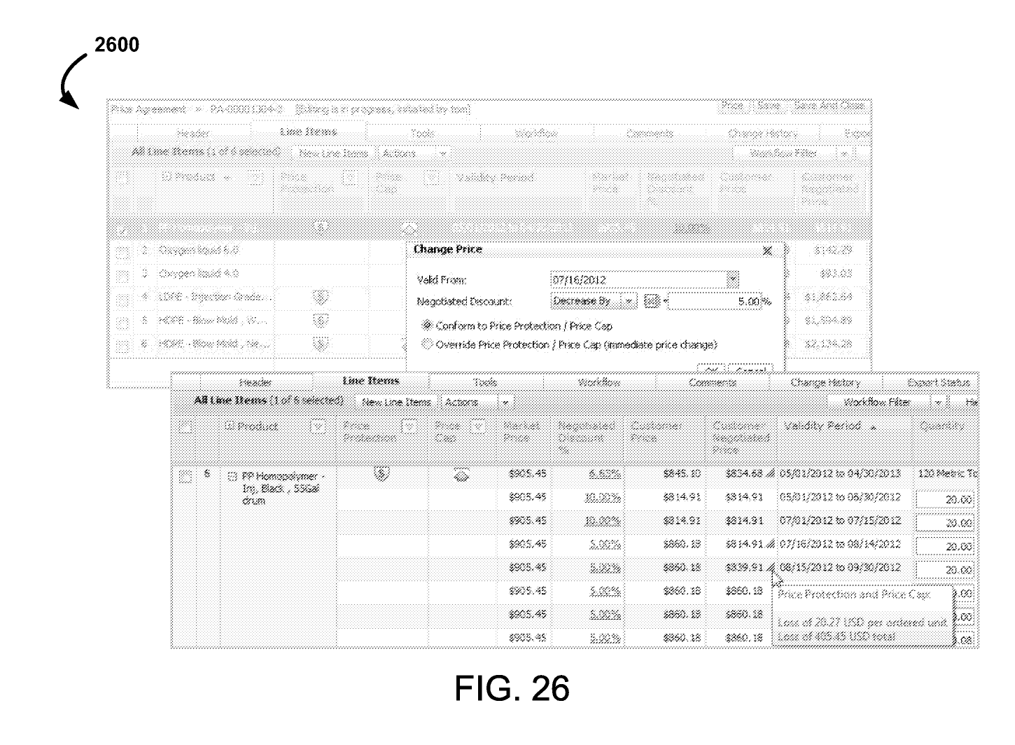

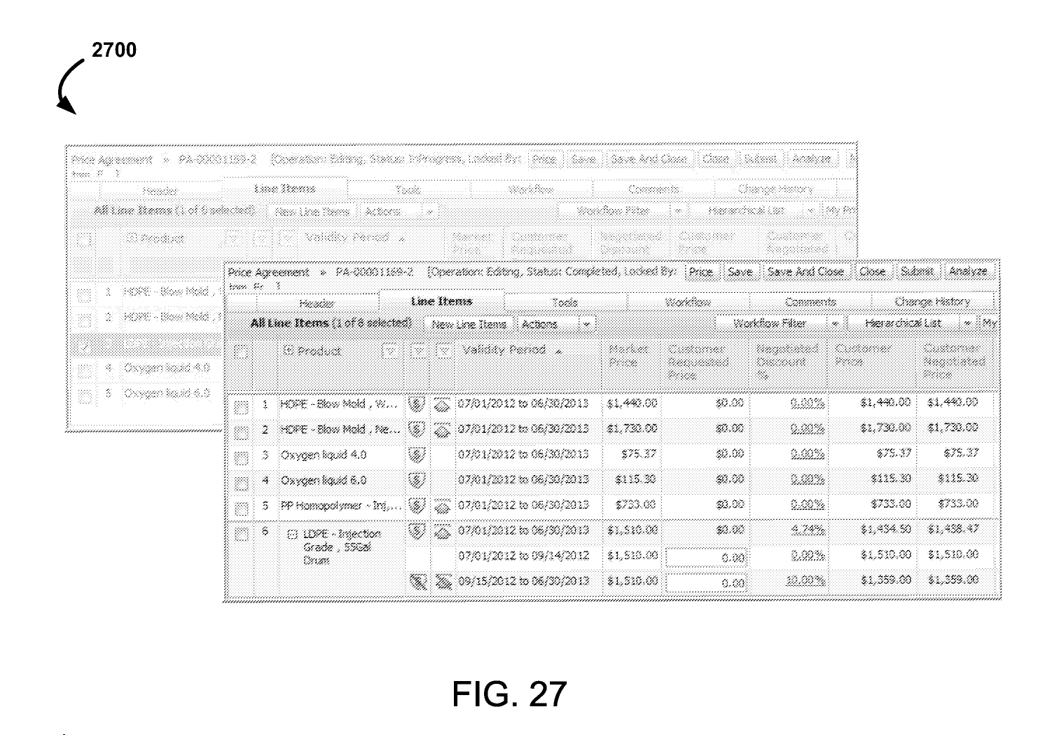

FIG. 26 provides an example screenshot 2600 of an enterprise pricing system interface where the price protection and price cap terms are being enforced on a manual price change. Further, FIG. 27 provides an example screenshot 2700 of an enterprise pricing system interface where those terms are being overridden. In this manner the manual price change can be effectuated by “overriding” the terms. The price change will thus be applied immediately without delay.

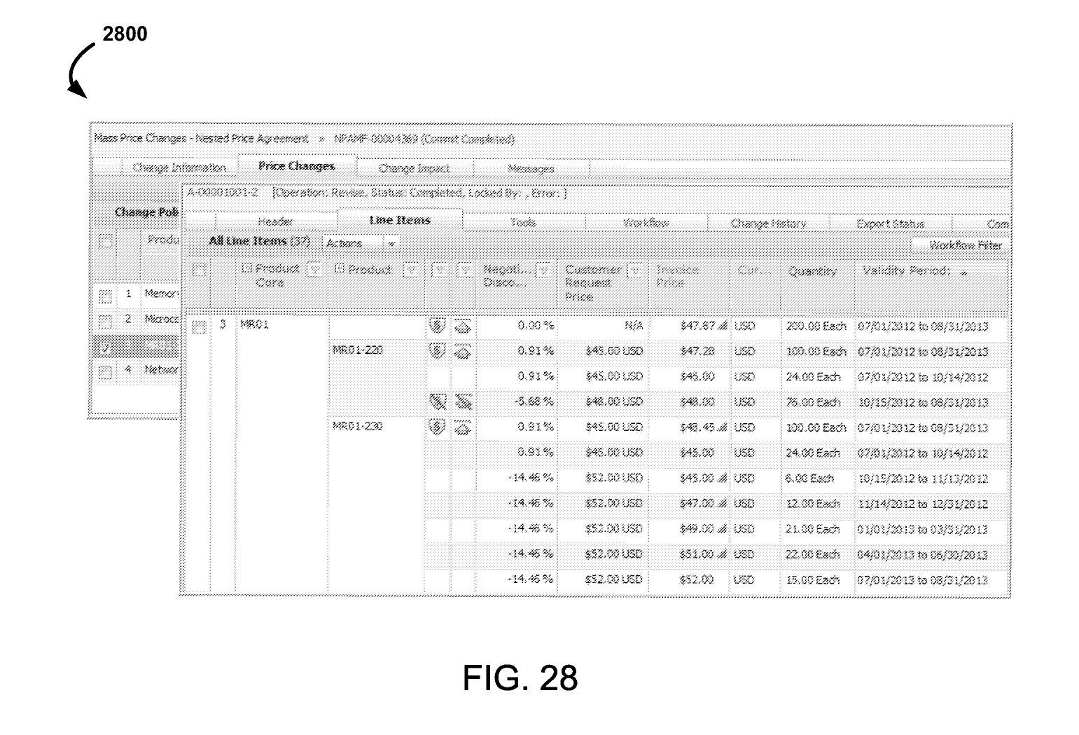

FIG. 28 provides an example screenshot 2800 of an enterprise pricing system interface where the price protection and price cap terms are being enforced and overridden on a mass price change. This enables a user to enforce or override the price protection and price cap terms using pricing policy during mass price changes.

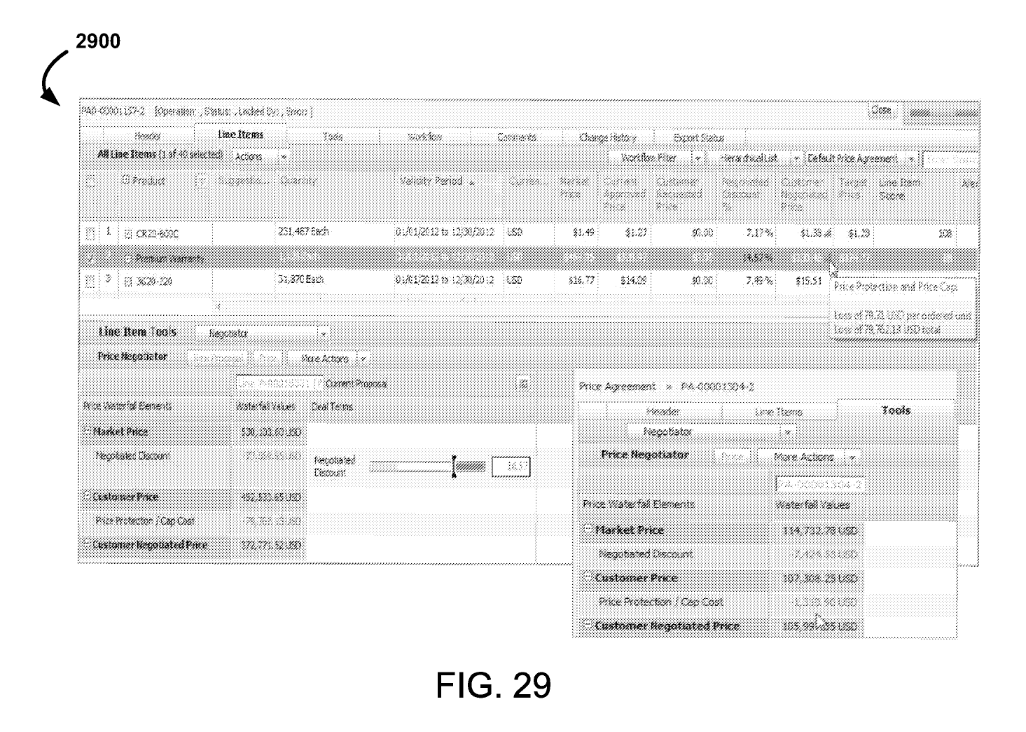

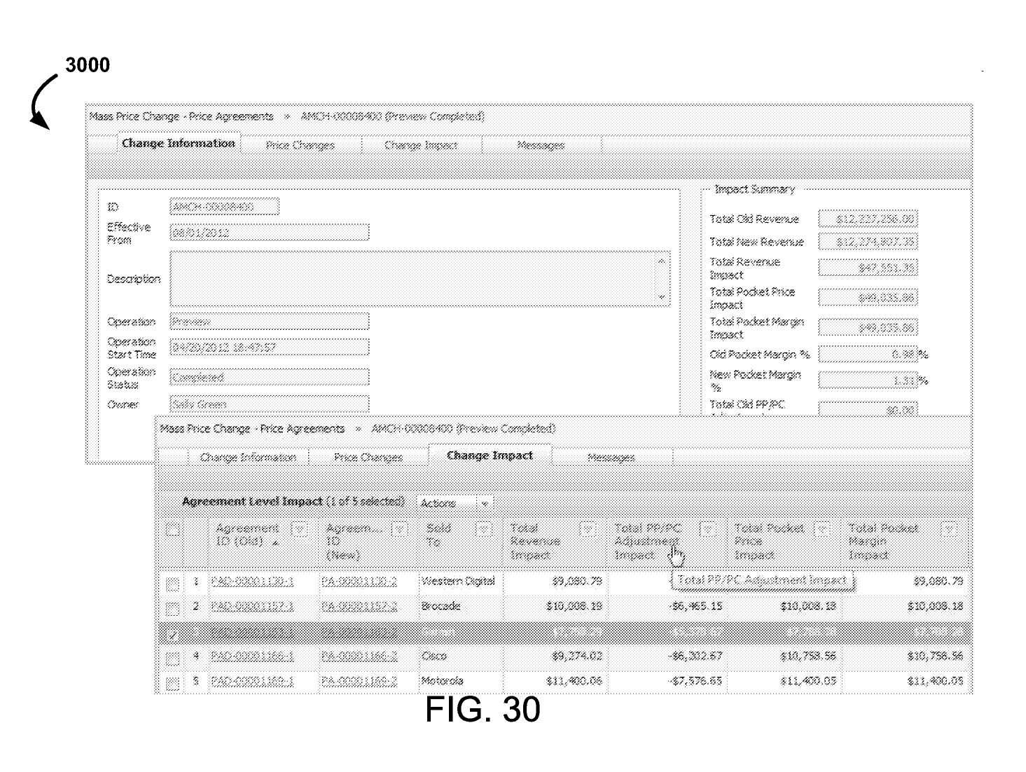

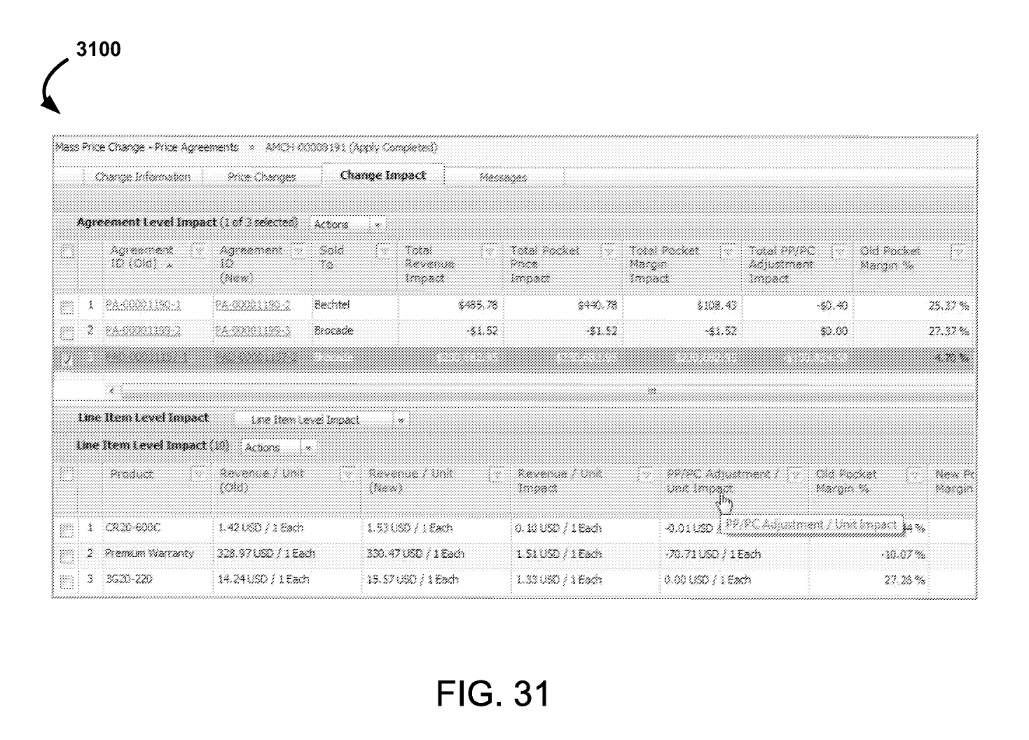

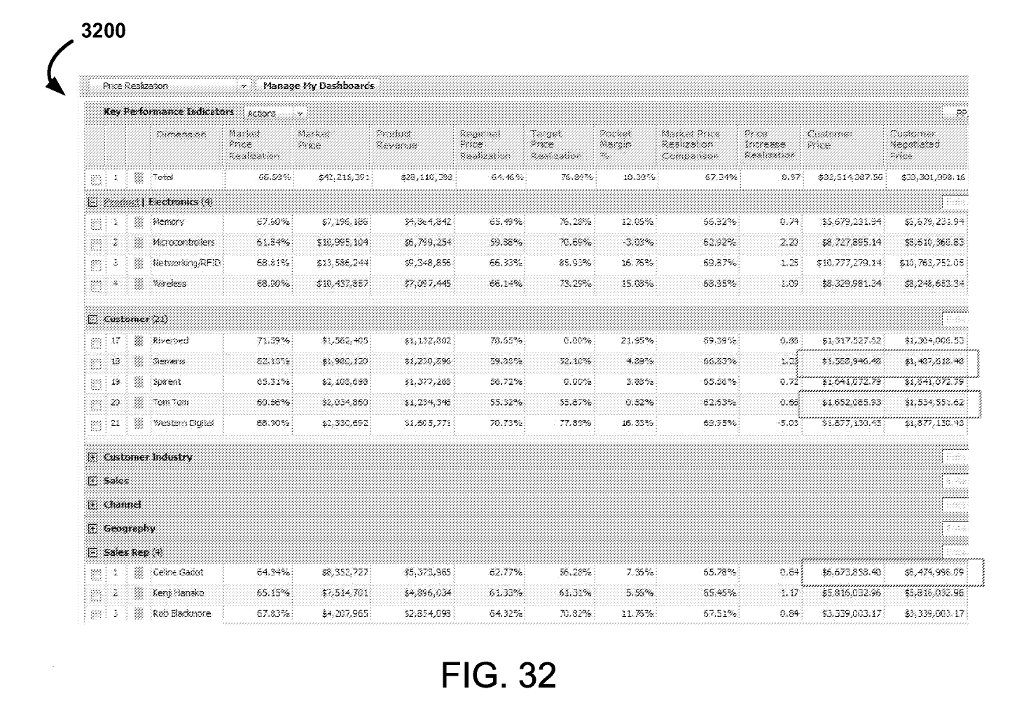

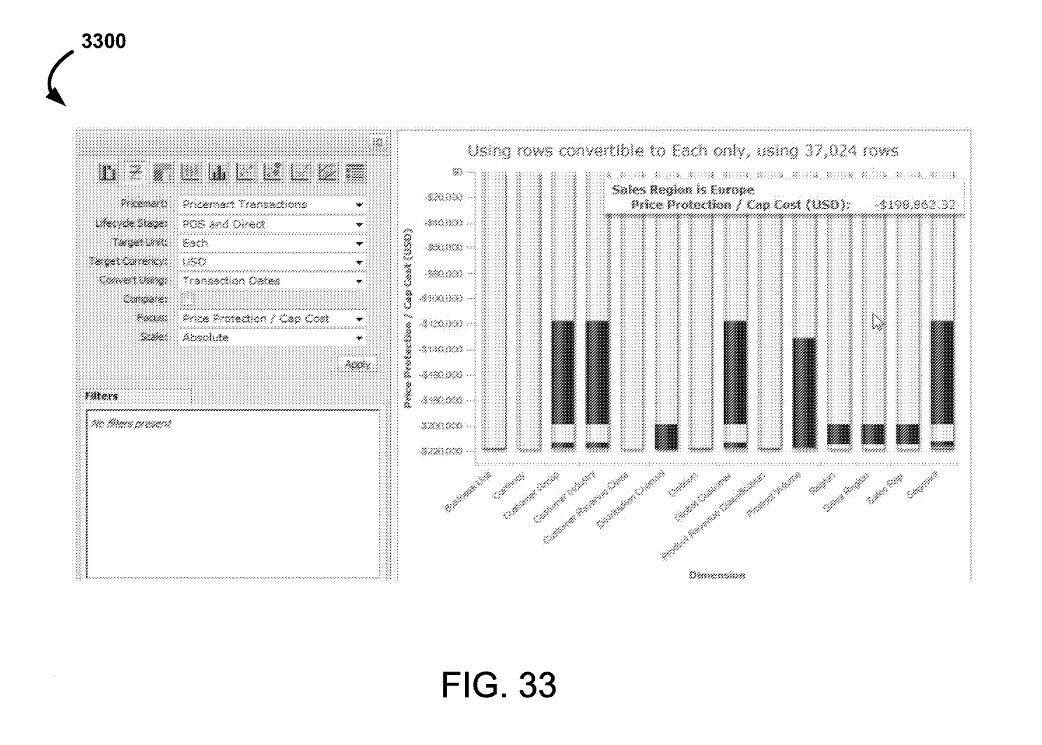

FIG. 29 provides an example screenshot 2900 of an enterprise pricing system interface where price leakage is being analyzed for. As previously noted, leakage may be analyzed for on the item level, deal level, customer level and sales representative level. Likewise, FIGS. 30 and 31 provide example screenshots 3000 and 3100, respectively, of an enterprise pricing system interface where price change realization is being analyzed for. Furthermore, FIGS. 32 and 33 provide example screenshots 3200 and 3300, respectively, of an enterprise pricing system interface where the price realization, caused by price protection and price cap terms, is being analyzed for. As previously noted, by visualizing these impacts attributable to price protection and price caps, better and more profitable deals may be negotiated.

### V. System Embodiments

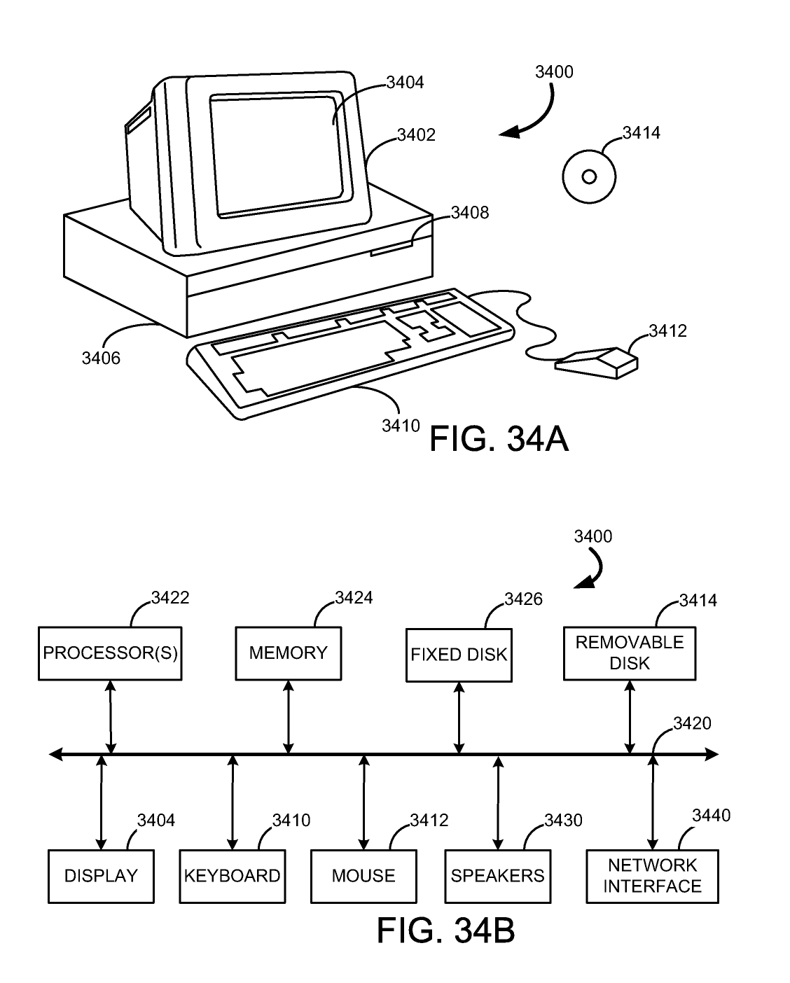

FIGS. 34A and 34B illustrate a Computer System 3400, which is suitable for implementing embodiments of the present invention. FIG. 34A shows one possible physical form of the Computer System 3400. Of course, the Computer System 3400 may have many physical forms ranging from a printed circuit board, an integrated circuit, and a small handheld device up to a huge super computer. Computer system 3400 may include a Monitor 3402, a Display 3404, a Housing 3406, a Disk Drive 3408, a Keyboard 3410, and a Mouse 3412. Disk 3414 is a computer-readable medium used to transfer data to and from Computer System 3400.

FIG. 34B is an example of a block diagram for Computer System 3400. Attached to System Bus 3420 are a wide variety of subsystems. Processor(s) 3422 (also referred to as central processing units, or CPUs) are coupled to storage devices, including Memory 3424. Memory 3424 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 3426 may also be coupled bi-directionally to the Processor 3422; it provides additional data storage capacity and may also include any of the computer-readable media described below. Fixed Disk 3426 may be used to store programs, data, and the like and is typically a secondary storage medium (such as a hard disk) that is slower than primary storage. It will be appreciated that the information retained within Fixed Disk 3426 may, in appropriate cases, be incorporated in standard fashion as virtual memory in Memory 3424. Removable Disk 3414 may take the form of any of the computer-readable media described below.

Processor 3422 is also coupled to a variety of input/output devices, such as Display 3404, Keyboard 3410, Mouse 3412 and Speakers 3430. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 3422 optionally may be coupled to another computer or telecommunications network using Network Interface 3440. With such a Network Interface 3440, it is contemplated that the Processor 3422 might receive information from the network, or might output information to the network in the course of performing the above-described multi-merchant tokenization. Furthermore, method embodiments of the present invention may execute solely upon Processor 3422 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, systems and methods for price protection and price caps are provided. While a number of specific examples have been provided to aid in the explanation of the present invention, it is intended that the given examples expand, rather than limit the scope of the invention. Although sub-section titles have been provided to aid in the description of the invention, these titles are merely illustrative and are not intended to limit the scope of the present invention.

While the system and methods has been described in functional terms, embodiments of the present invention may include entirely hardware, entirely software or some combination of the two. Additionally, manual performance of any of the methods disclosed is considered as disclosed by the present invention.

While this invention has been described in terms of several preferred embodiments, there are alterations, permutations, modifications and various substitute equivalents, which fall within the scope of this invention. It should also be noted that there are many alternative ways of implementing the methods and systems of the present invention. It is therefore intended that the following appended claims be interpreted as including all such alterations, permutations, modifications, and various substitute equivalents as fall within the true spirit and scope of the present invention.

What is claimed is:

1. A method for impact analysis of price protection and price cap terms, useful in association with an integrated price management system, the method comprising:
negotiating at least one of a price protection and a price cap term within a deal, wherein the price protection term limits when a price change can go into effect, and further wherein a price cap term limits the degree of price change allowed in a given period;
enforce the at least one price protection and price cap term; and
analyze for price leakage by product, by deal, by customer and by sales representative.

2. The method of claim 1, wherein the negotiation of the price protection and the price cap term includes at least one of the adding of a new term, the editing of the term, the ending of the term, renewal of the term, and workflow approval of the term.

3. The method of claim 1, wherein the enforcement of the at least one price protection and price cap term includes applying the term on at least one of a manual price change and a mass price change.

4. The method of claim 1, wherein the enforcement of the at least one price protection and price cap term includes overriding the term on at least one of a manual price change and a mass price change.

5. The method of claim 1, wherein the analysis for price leakage includes generating a waterfall for the deal.

6. The method of claim 5, wherein the analysis for price leakage includes generating an adjustment for all price protection and price cap terms, and applying the adjustment to the waterfall.

7. The method of claim 5, wherein the analysis for price leakage includes generating a price protection adjustment for the price protection term and a price cap adjustment for the price cap term, and applying the price protection adjustment and the price cap adjustment to the waterfall.

8. The method of claim 1, wherein the price protection term includes a validity range, type, and period.

9. The method of claim 8, wherein the type is one of delayed, firm-trough, or rolling.

10. The method of claim 1, wherein price protection term includes a validity range, a base price, a periodic increase cap, a periodic decrease cap, an overall increase cap, an overall decrease cap, a periodic length, and an overall length.

11. A system for analyzing impact of price protection and price cap terms comprising:
an enterprise pricing system, including a processor and computer readable media that when read by the processor completes the steps of:
negotiating at least one of a price protection and a price cap term within a deal, wherein the price protection term limits when a price change can go into effect, and further wherein a price cap term limits the degree of price change allowed in a given period;
enforce the at least one price protection and price cap term; and
analyze for price leakage by product, by deal, by customer and by sales representative.

12. The system of claim 11, wherein the negotiation of the price protection and the price cap term includes at least one of the adding of a new term, the editing of the term, the ending of the term, renewal of the term, and workflow approval of the term.

13. The system of claim 11, wherein the enforcement of the at least one price protection and price cap term includes applying the term on at least one of a manual price change and a mass price change.

14. The system of claim 11, wherein the enforcement of the at least one price protection and price cap term includes overriding the term on at least one of a manual price change and a mass price change.

15. The system of claim 11, wherein the analysis for price leakage includes generating a waterfall for the deal.

16. The system of claim 15, wherein the analysis for price leakage includes generating an adjustment for all price protection and price cap terms, and applying the adjustment to the waterfall.

17. The system of claim 15, wherein the analysis for price leakage includes generating a price protection adjustment for the price protection term and a price cap adjustment for the price cap term, and applying the price protection adjustment and the price cap adjustment to the waterfall.

18. The system of claim 11, wherein the price protection term includes a validity range, type, and period.

19. The system of claim 18, wherein the type is one of delayed, firm-trough, or rolling.

20. The system of claim 11, wherein price protection term includes a validity range, a base price, a periodic increase cap, a periodic decrease cap, an overall increase cap, an overall decrease cap, a periodic length, and an overall length.
